(19) United States
(12) Patent Application Publication
(10) Pub. No.: US 2021/0383370 A1
(43) Pub. Date: Dec. 9, 2021

(54) ENHANCED MULTI-PARTY USER DATA DELETION

(71) Applicant: RIVN Co., LLC, Draper, UT (US)

(72) Inventors: Jeremiah Tippets, American Fork, UT (US); Glen Horsley, Pleasant Grove, UT (US); Keri Anderson, Draper, UT (US)

(21) Appl. No.: 16/894,478

(22) Filed: Jun. 5, 2020

(51) Int. Cl. G06Q 20/38; G06Q 20/40; G06F 21/62; G06F 21/31

(52) U.S. Cl. CPC G06Q 20/383; G06Q 20/405; G06F 2221/2151; G06F 21/31; G06F 21/6245

(57) ABSTRACT

Various systems, methods, and other aspects improve processes for handling user data deletion requests where such user data is stored in third-party data stores. For instance, a method may include receiving a data deletion request, determining a third-party data processor; and sending a user identification request via the network to the third-party data processor that includes a unique user identifier for the user. The method may receive a user identification response confirming that the third-party data processor is storing the information about the user, and responsively send a third-party data deletion request to the third-party data processor requesting that the information stored about the user in the third-party data store. In response, the method receives a third-party data deletion response including a transaction identifier for the third-party data deletion request and stores it. The transaction identifier can then be used to help ensure that the information is eventually deleted.

### TECHNICAL FIELD

The present disclosure relates to data deletion, and in a more particular non-limiting example, detecting third-party data tracking, and generating and managing third-party data deletion requests.

### BACKGROUND

With the boom in internet advertising, huge amounts of data are often collected by many different parties about an individual's activities on the internet, as well as many different aspects of their offline life. This information can be very valuable to companies to present targeted advertising but raise many concerns about the use of this personal data. In response, governments around the world are enacting regulations governing the collection and use of personal data that can be used to identify and target users.

Numerous jurisdictions have passed legislation regulating privacy and the personal data collection activities of companies. For example, in 2016, the European Union passed the General Data Protection Regulation (GDPR), which went into effect in 2018. Like other privacy legislation, it requires that all companies that do business with any EU citizen comply with numerous requirements based on the core principals of lawfulness, fairness, transparency, limited purpose, data minimization, limited storage, security, and accountability.

Notably, GDPR provides users with the “right of erasure,” also known as the “right to be forgotten.” This data deletion right requires companies to delete a user's personal data responsive to the user requesting it without undue delay (within one month of receipt). Under GDPR, companies are required to have processes and procedures set up to handle such requests, including managing the lifecycle of the requests, locating and deleting the relevant data, notifying data processors to delete the relevant data, and so forth.

If companies fail to comply, GDPR provides for significant fines of up to 20 Million Euros or 4% of total revenue. However, due to the difficulty of complying, some companies have opted for a higher-risk approach and continued operations undeterred, which could result in massive fines, erosion of user-confidence, litigation, and even bankruptcy. Others have elected to step back from marketing in the EU until they comply, forgoing revenue and market share in the process.

The California Consumer Privacy Act (CCPA) went into effect on Jan. 1, 2020, with similar requirements to GDPR and severe fines for non-compliance that could, in some instances, be even larger than those levied by GDPR. CCPA also includes a data deletion right requiring companies to inform users of this right and delete a user's personal data upon request.

This regulatory environment is likely to grow much more complex as numerous other countries and states have just passed or are considering their own privacy laws that include a data deletion right. These new data deletion rights may not be consistent with existing ones and make compliance even more challenging.

Complying with the numerous different “right to be forgotten” laws is in no way trivial and requires a significant investment by companies, particularly those with hundreds of thousands or millions of users. In particular, companies are required to redesign non-complaint software, hire and train personnel, revise and implement appropriate data policies, maintain and preserve records, etc., which can take several months or years to properly implement. This is exacerbated by the exponential rise in the number of data deletion request companies receive year to year.

### SUMMARY

The present disclosure overcomes the deficiencies and limitations of the prior art at least in part by providing systems, methods, computer program products, and other aspects for at least detecting third-party data tracking, and generating and managing third-party data deletion requests. In general, one innovative aspect of the subject matter described in this disclosure includes a computer-implemented method that receives a data deletion request via a network from a client application. The data deletion request requests deletion of data about a user. The method further includes determining a third-party data processor and sending a user identification request via the network to the third-party data processor. The user identification request includes a unique user identifier for the user and requesting confirmation that the third-party data processor has stored information about the user in a third-party data store.

The method further includes receiving, via the network, a user identification response confirming that the third-party data processor is storing the information about the user, and responsive to receiving the user identification response, sending, via the network, a third-party data deletion request to the third-party data processor requesting that the third-party data processor delete the information stored about the user in the third-party data store. The third-party data deletion request includes the unique user identifier. The method further includes receiving, via the network from the third-party data processor, a third-party data deletion response including a transaction identifier for the third-party data deletion request and updating, in a data compliance data store, a data deletion record to include the transaction identifier and a timestamp for the third-party data deletion request.

These or other method implementations may include one or more of the following features: that determining a third-party data processor may include determining profile data of the third-party data processor, retrieving third-party tracking data associated with the user from a local memory of a computing device of the user, determining, using the profile data of the third-party data processor, and generating the third-party data deletion request that includes the unique user identifier; that the third-party tracking data includes a unique user identifier that the third-party data processor uses to uniquely identify the user determining a plurality of third-party data processors associated with a web site loaded in the client application of the user; providing a user interface for presentation to the user; that the user interface includes a plurality of user-interactable elements for interacting with the plurality of third-party data processors, respectively; receiving an input via an input device of the computing device of the user; that the input selects the third-party data processor via a corresponding user-interactable element from the plurality of user-interactable elements of the user interface; for an interval after receipt of the third-party data deletion response, sending, via the network, a periodic status request to the third-party data processor; that the periodic status request includes the transaction identifier and requests confirmation that the information stored about the user was successfully deleted from the third-party data store; receiving, via the network from the third-party data processor, a completion response including the transaction identifier and data verifying that the information stored about the user was deleted from the third-party data store; updating, in the data compliance data store, the data deletion record to reflect that the third-party data deletion request was successful and to include a completion timestamp; that the third-party data deletion response confirms that the information stored about the user has been deleted from the third-party data store; updating the data deletion record to reflect that the third-party data deletion request was successful and to include a completion timestamp; generating an electronic notification reflecting that the information stored about the user was deleted from the third-party data store; sending the electronic notification to an electronic address of the user via the network; receiving, via the network from the third-party data processor, a completion response including the transaction identifier and verification data verifying that the information stored about the user was deleted from the third-party data store; updating, in the data compliance data store, the data deletion record to reflect that the third-party data deletion request was successful and to include a completion timestamp; for an interval beginning after receipt of the completion response, sending, via the network, a periodic compliance request to the third-party data processor; that the periodic compliance request includes the unique user identifier and requesting a subsequent confirmation confirming whether any portion of the information about the user has reappeared in the third-party data store; receiving, from the third-party data processor, a compliance response reflecting that at least a portion of the information about the user that reappeared in the third-party data store; initiating a subsequent iteration of the computer-implemented method to delete the at least the portion of the information about the user that reappeared in the third-party data store; responsive to the interval ending, determining that a compliance criterion is satisfied; generating an electronic notification reflecting that the information stored about the user successfully was deleted from the third-party data store; sending the electronic notification to an electronic address of the user via the network; purging from the data compliance data store, user-identifying data associated with the data deletion request and the third-party data deletion request; that the data deletion request includes an electronic address of the user; sending, via the network, a request confirmation notification to the electronic address of the user; receiving, via the network, a response from the electronic address of the user consenting to the third-party data deletion request; updating, the data compliance data store, the data deletion record to reflect the third-party data deletion request has been consented to by the user; that the data deletion request is received via the API; and that the user identification request and the third-party deletion requests are sent to the third-party data processor via corresponding APIs exposed by a third-party application of the third-party data processor.

In general, another innovative aspect includes a system having one or more memories storing instructions, which when executed by the one or more processors, cause the system to perform operations that include receiving a data deletion request via a network from a client application. The data deletion request requests deletion of data about a user. The operations further include determining a third-party data processor and sending a user identification request via the network to the third-party data processor. The user identification request includes a unique user identifier for the user and requests confirmation that the third-party data processor has stored information about the user in a third-party data store. The operations further include receiving, via the network, a user identification response confirming that the third-party data processor is storing the information about the user and responsive to receiving the user identification response, sending, via the network, a third-party data deletion request to the third-party data processor requesting that the third-party data processor delete the information stored about the user in the third-party data store. The third-party data deletion request includes the unique user identifier. The operations further include receiving, via the network from the third-party data processor, a third-party data deletion response including a transaction identifier for the third-party data deletion request and updating, in a data compliance data store, a data deletion record to include the transaction identifier and a timestamp for the third-party data deletion request.

These or other system implementations may include one or more of the following features: that determining a third-party data processor may include determining profile data of the third-party data processor, retrieving third-party tracking data associated with the user from a local memory of a computing device of the user, determining, using the profile data of the third-party data processor, that the third-party tracking data includes a unique user identifier that the third-party data processor uses to uniquely identify the user, generating the third-party data deletion request that includes the unique user identifier; that determining a third-party data processor may include determining a plurality of third-party data processors associated with a web site loaded in the client application of the user, providing a user interface for presentation to the user, receiving an input via an input device of the computing device of the user; that the user interface includes a plurality of user-interactable elements for interacting with the plurality of third-party data processors, respectively; that the input selects the third-party data processor via a corresponding user-interactable element from the plurality of user-interactable elements of the user interface; that determining a third-party data processor may include, for an interval after receipt of the third-party data deletion response, sending, via the network, a periodic status request to the third-party data processor, receiving, via the network from the third-party data processor, a completion response including the transaction identifier and data verifying that the information stored about the user was deleted from the third-party data store, and updating, in the data compliance data store, the data deletion record to reflect that the third-party data deletion request was successful and to include a completion timestamp; that the periodic status request includes the transaction identifier and requests confirmation that the information stored about the user was successfully deleted from the third-party data store; that the third-party data deletion response confirms that the information stored about the user has been deleted from the third-party data store; that the operations further comprise updating the data deletion record to reflect that the third-party data deletion request was successful and to include a completion timestamp, generating an electronic notification reflecting that the information stored about the user was deleted from the third-party data store, and sending the electronic notification to an electronic address of the user via the network; that the operations may further include receiving, via the network from the third-party data processor, a completion response including the transaction identifier and verification data verifying that the information stored about the user was deleted from the third-party data store, updating, in the data compliance data store, the data deletion record to reflect that the third-party data deletion request was successful and to include a completion timestamp, and for an interval beginning after receipt of the completion response, sending, via the network, a periodic compliance request to the third-party data processor, the periodic compliance request including the unique user identifier and requesting a subsequent confirmation confirming whether any portion of the information about the user has reappeared in the third-party data store; that the operations further comprise receiving, from the third-party data processor, a compliance response reflecting that at least a portion of the information about the user that reappeared in the third-party data store, and initiating a subsequent iteration of at least a portion of the operations to delete the at least the portion of the information about the user that reappeared in the third-party data store; that the operations further include, responsive to the interval ending, determining that a compliance criterion is satisfied, generating an electronic notification reflecting that the information stored about the user successfully was deleted from the third-party data store, sending the electronic notification to an electronic address of the user via the network, and purging from the data compliance data store, user-identifying data associated with the data deletion request and the third-party data deletion request; that the data deletion request includes an electronic address of the user; and that the operations further include sending, via the network, a request confirmation notification to the electronic address of the user; receiving, via the network, a response from the electronic address of the user consenting to the third-party data deletion request; and updating, the data compliance data store, the data deletion record to reflect the third-party data deletion request has been consented to by the user.

In general, another innovative aspect includes a method that stores, in a data compliance data store in association with a first-party application, a plurality of third-party application programming interface (API) profiles respectively associated with a plurality of third-party applications, and receives a data deletion request via a network via the first-party application. The data deletion request requests deletion of data about a user. The method further includes retrieving, from the data compliance data store, the plurality of third-party API profiles associated with the first-party application, generating, for each third-party application of the plurality of third-party applications, a corresponding a third-party data deletion request based on a corresponding third-party API profile from the plurality of third-party API profiles, and sending, via the network, each third-party data deletion request to the corresponding third-party application via a corresponding API of the third-party application. Each third-party data deletion request requests that the corresponding third-party application delete information stored about the user from a third-party data store of the third-party application. The method further includes receiving, via the network, a third-party data deletion response from each third-party application of the plurality of third-party applications. The third-party data deletion response includes a corresponding transaction identifier. The method further includes updating, in a data compliance data store, a data deletion record to include the corresponding transaction identifier and a timestamp for each third-party data deletion request.

Other aspects include, but are not limited to, corresponding systems, methods, apparatuses, computer program products.

These systems, methods, apparatus, and computer program products, and other aspects, are particularly advantageous in a number of respects, including reducing manual overhead, network traffic, and ad-hoc requests associated with deleting personal data; batching third-party data deletion requests to third-party data processors; providing an API hub for sending and receiving communication related to first and third-party data deletion request; consolidating previously disparate requests into novel, streamlined user interfaces and communication flow; helping to ensure compliance with technically challenging data management and deletion requirements, particularly for applications that are at scale with thousands or millions of end-users. However, this list of features and advantages is not all-inclusive and many additional features and advantages are within the scope of the present disclosure. Moreover, it should be noted that the language used in the present disclosure has been principally selected for readability and instructional purposes, and not to limit the scope of the subject matter disclosed herein.

### BRIEF DESCRIPTION OF THE DRAWINGS

FIG. 1A illustrates a block diagram of an example system for detecting third-party data tracking and generating and managing third-party data deletion requests.

FIG. 18 illustrates a data flow diagram of the example system.

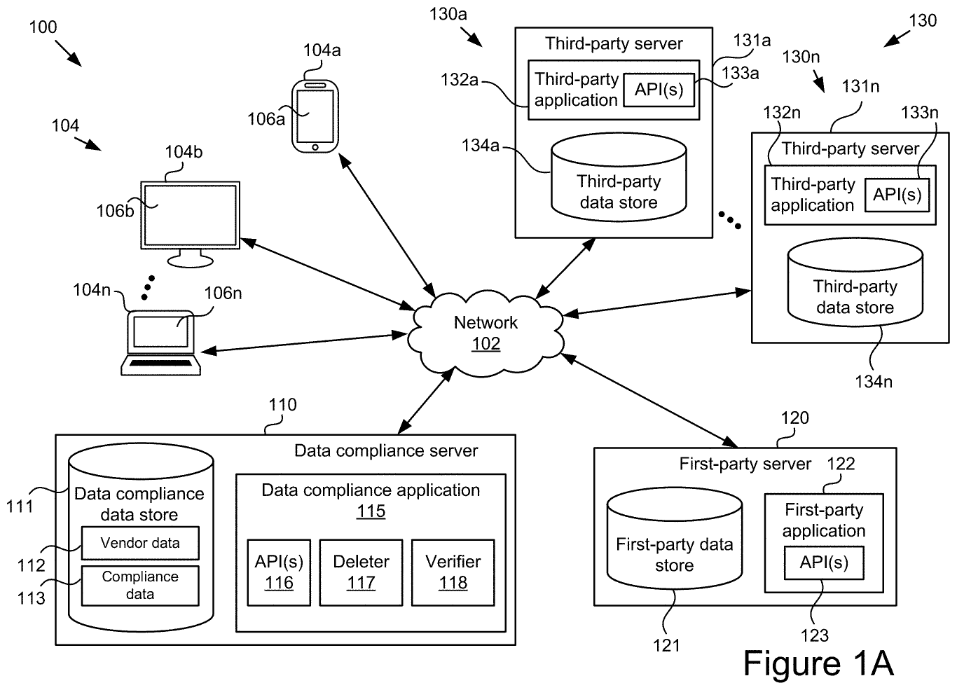

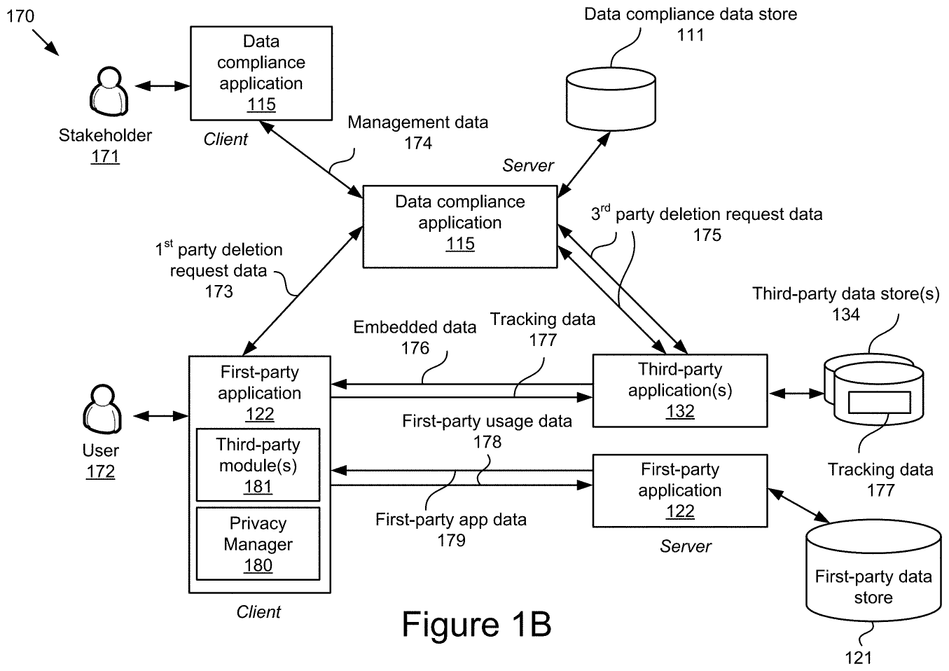

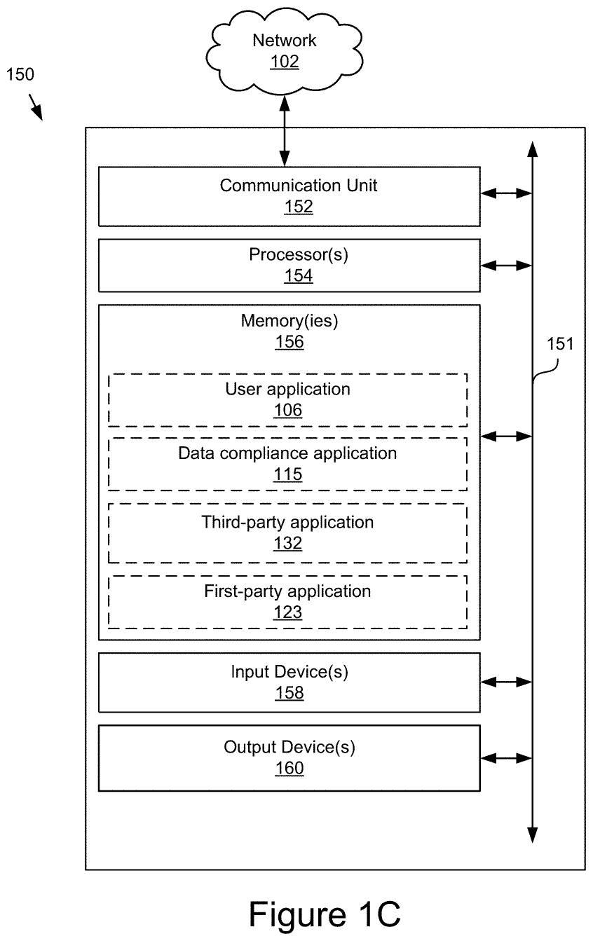

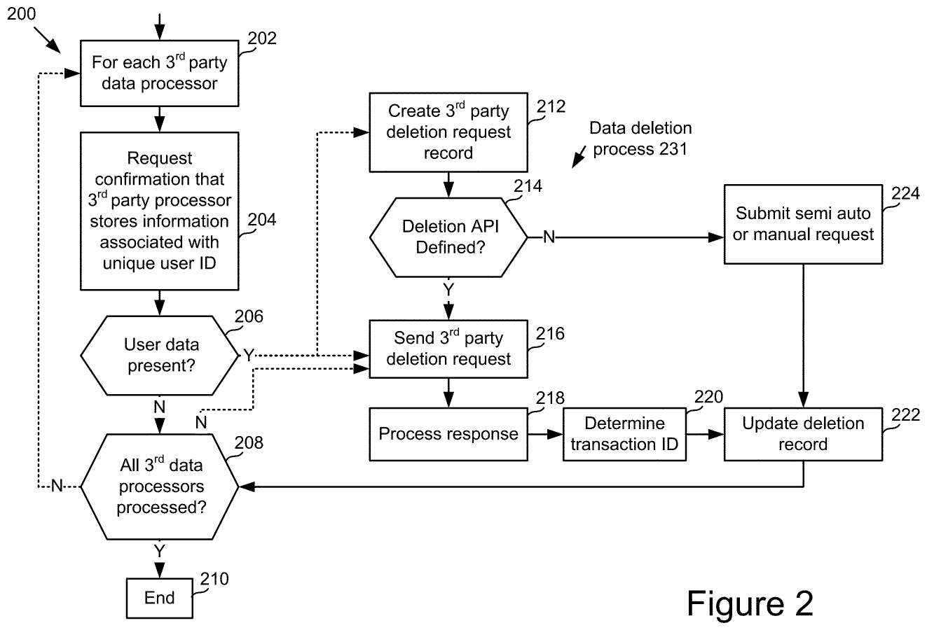

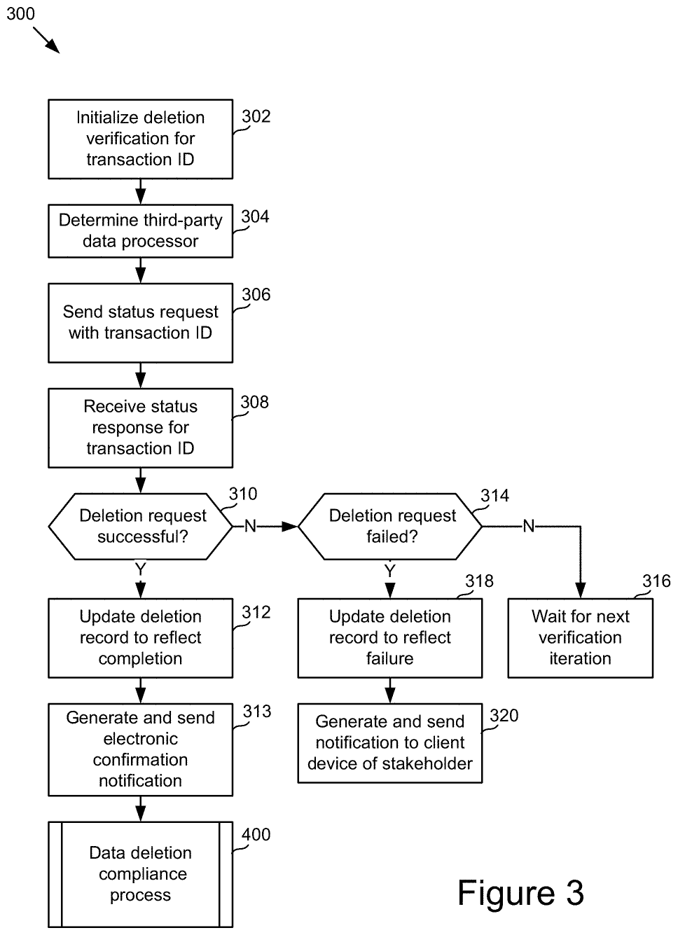

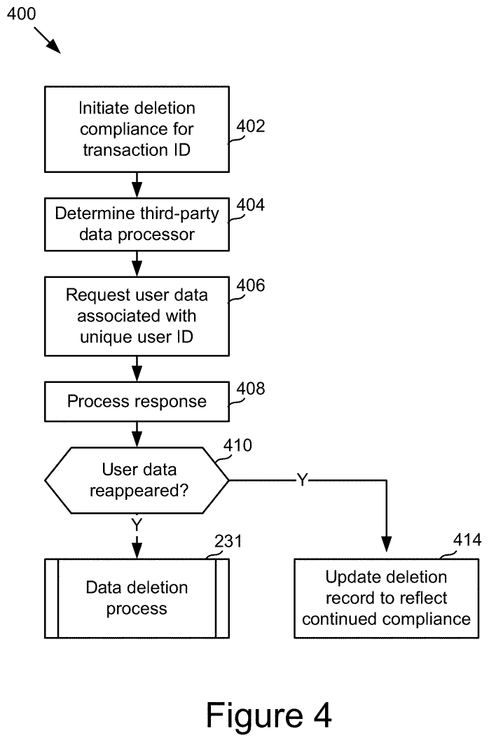

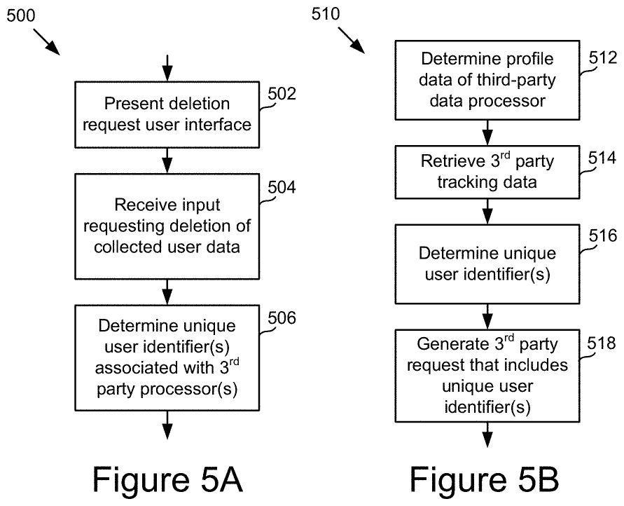

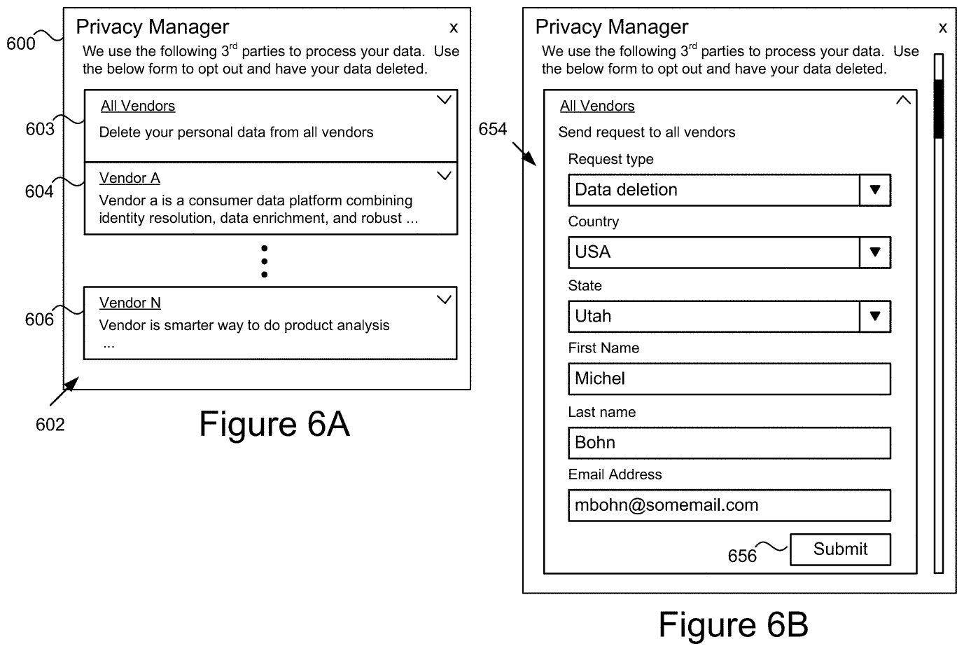

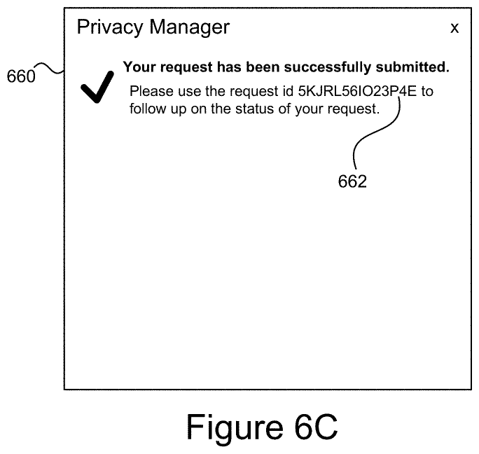

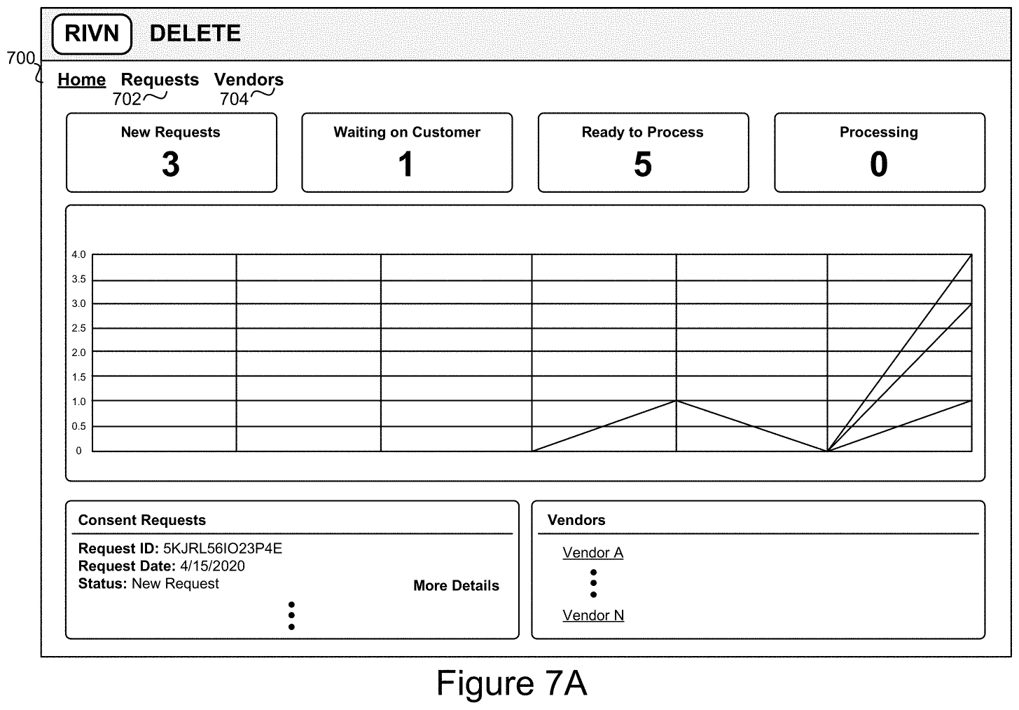

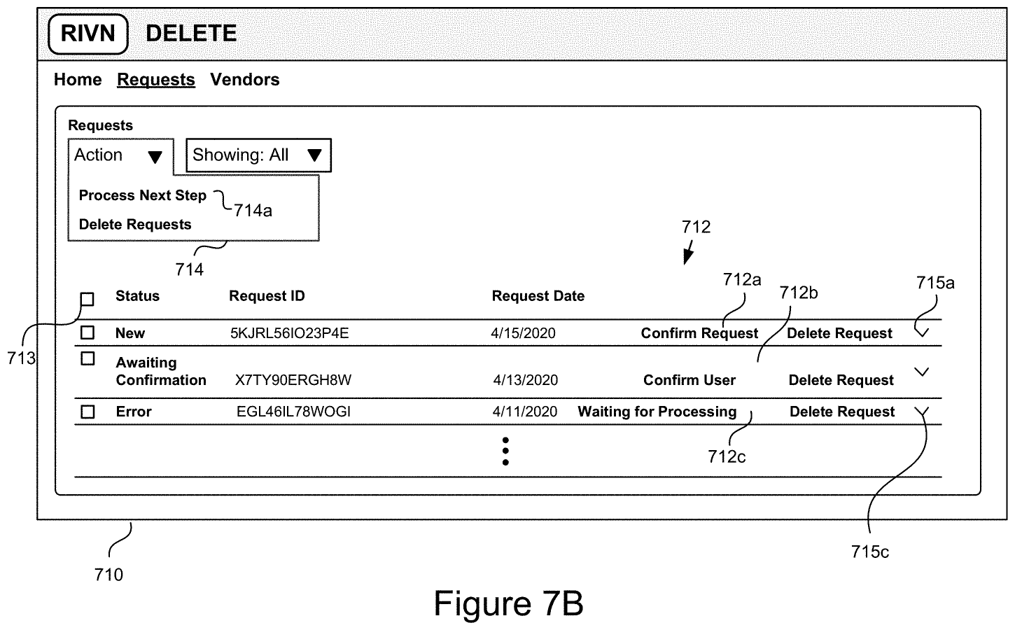

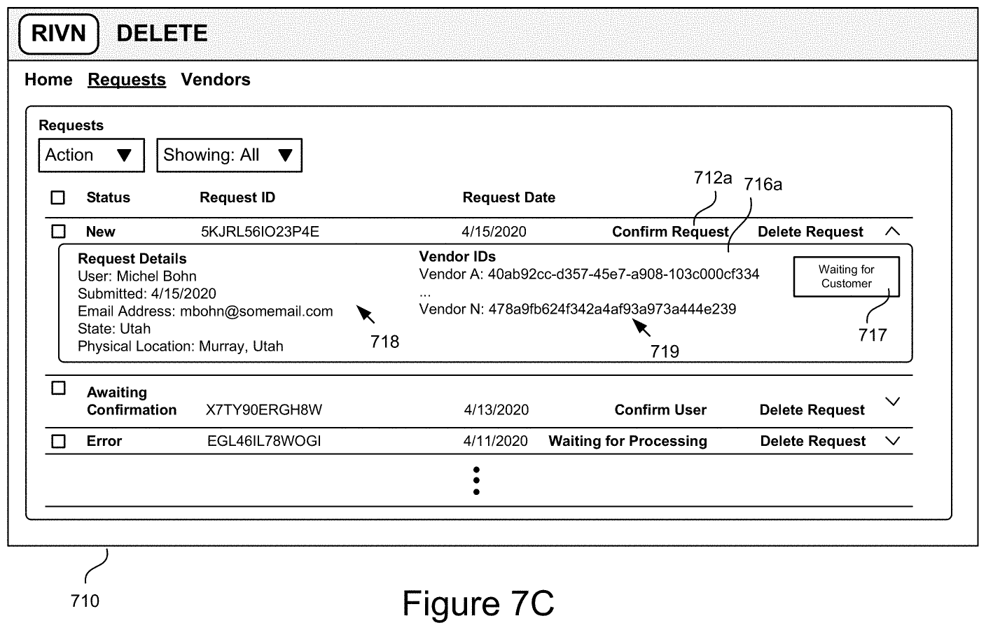

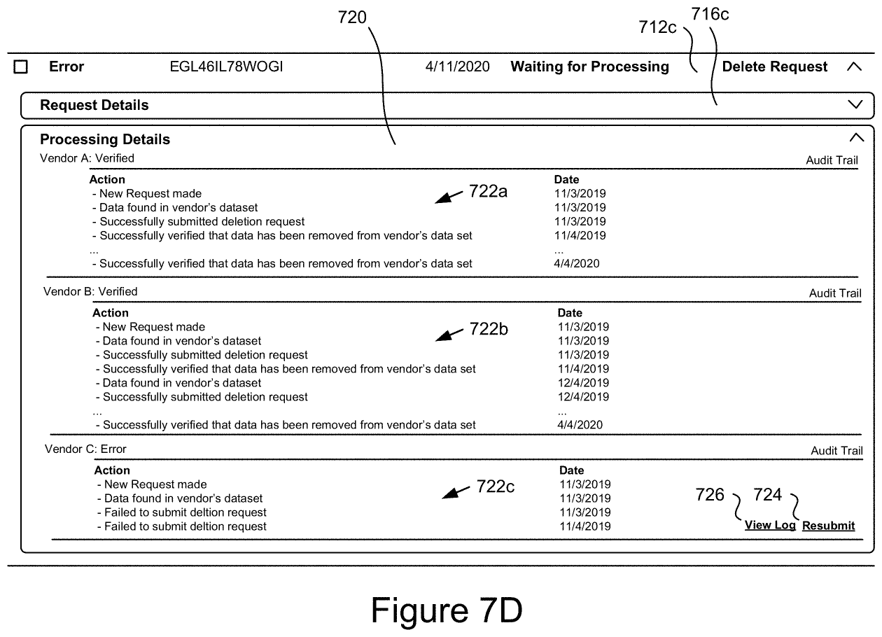

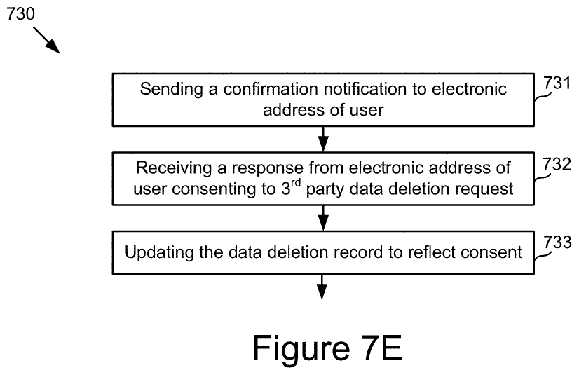

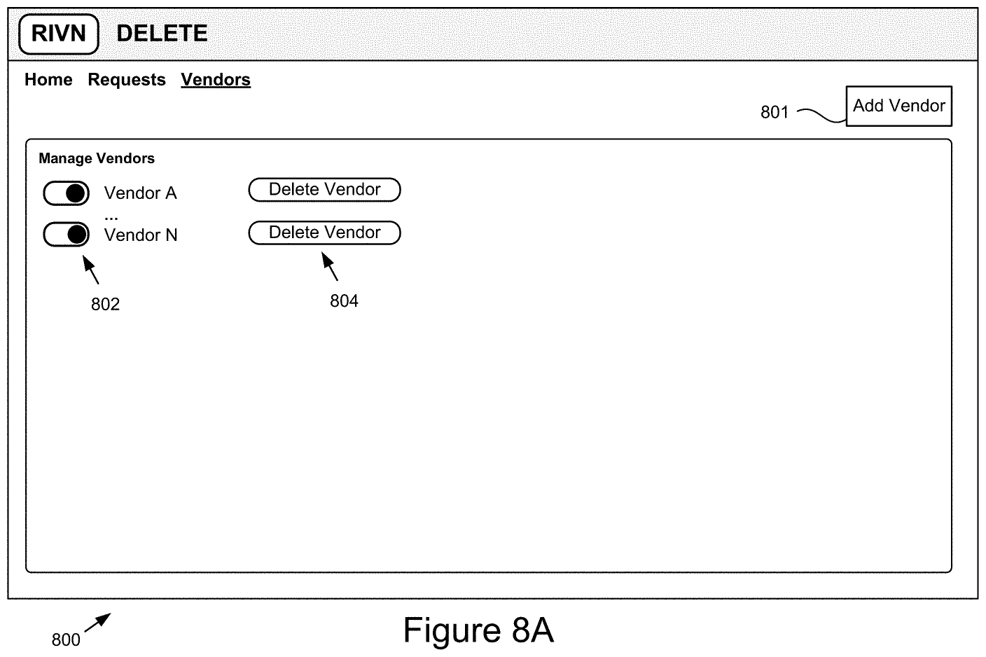

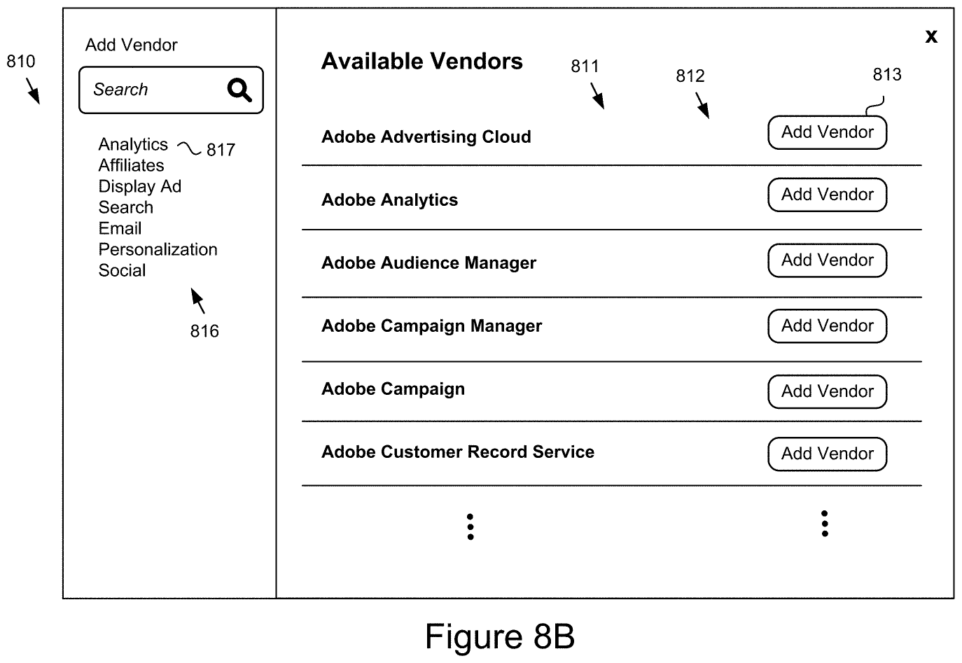

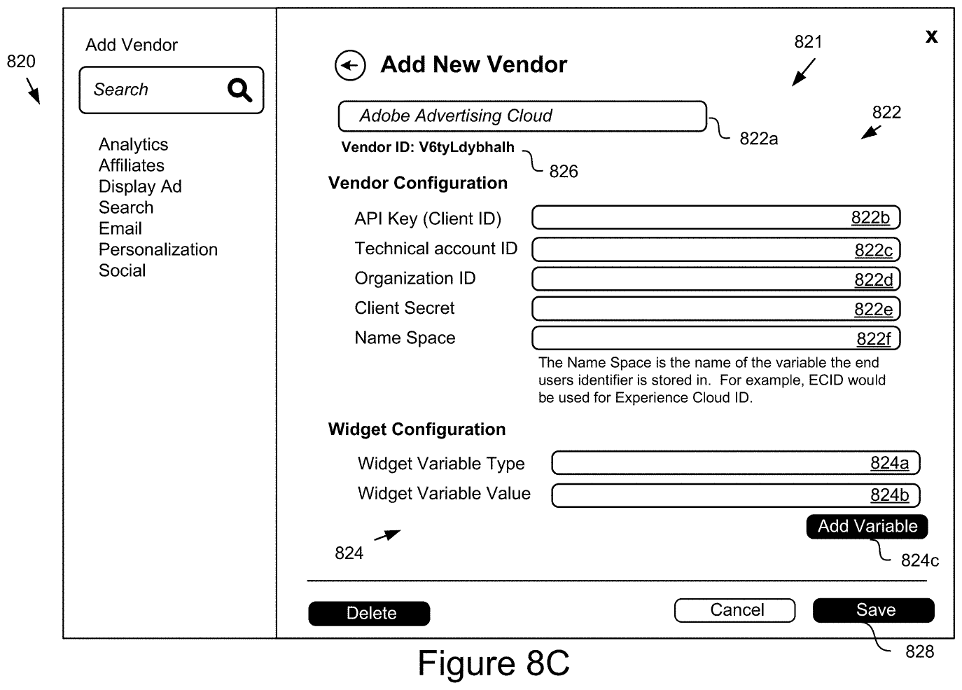

FIG. 1C illustrates a block diagram of an example computing device.

FIG. 2 is a flowchart of an example method for processing third-party data deletion requests.

FIG. 3 is a flowchart of an example method for verifying the third-party deletion of user data.

FIG. 4 is a flowchart of an example method for data deletion compliance.

FIG. 5A is a flowchart of an example method for determining user identifiers.

FIG. 5B is a flowchart of an example method for generating third-party data deletion requests that include unique user identifiers.

FIGS. 6A-6C illustrate example privacy manager user interfaces.

FIGS. 7A-7D illustrate example user interfaces for managing data deletion compliance.

FIG. 7E is a flowchart of an example method for verifying that a data deletion request is authorized.

FIGS. 8A-8C illustrate example request and vendor management user interfaces.

### DETAILED DESCRIPTION

This application discloses innovative technology for detecting third-party data tracking and generating and managing third-party data deletion requests. By way of illustration and not limitation, the technology may include a data compliance application that may serve as a hub for managing data deletion requests with third-party data processors. For example, the data compliance application may include application programming interfaces that automate the handling of data deletion requests for third party vendors.

In this example, the data compliance application may receive a user-initiated data deletion request via a first-party application. The data deletion request is a request initiated by a user of the first-party application (e.g., a web-based software service) requesting the operators of the first-party application delete data that the first-party application collected about a user. In some instances, a user may interact with a data compliance privacy component embedded in a web site of the first party that can conveniently identify the third-party applications used by the first-party, along with the unique identifiers used by the third parties to track the user, from the user's web browser for inclusion in the data deletion request, although other variations are also possible and contemplated.

In practice, a first-party application may use more than one, and often numerous (e.g., 10 or more) third-party applications for a variety of purposes, such as generating and providing website analytics; cookie management and scoring; tag management; advertisement monitoring, tracking, management, and optimization; marketing intelligence; click fraud detection; user profiling and tracking; and user targeting.

A third-party application acts as a data processor for the first-party, and as such, receives various data via the first-party application and processes it for various purposes. That data often includes personal information (which also is referred to herein as personal data, user data, user information, information about a user, etc.) about the users of the first-party application, such as a name, surname, age, gender, race, income, home address, city, state, and country of residence or work, geographic location, location history, Internet protocol (IP) address, cookie ID, device identifiers, product preferences, family relationships, friend relationships, medical history, financial information, and/or any other personal information. The third-party application generates and uses unique user identifiers, such as universally unique identifiers (UUIDs), globally unique identifiers (GUIDs), or other suitable identifiers, to organize each user's respective data in their respective data stores.

Once received, the data compliance application may process the data deletion request initiated by the user to determine the relevant third-party data processors, and then generate and send third-party data deletion requests to the respective third-party data processors. As an intermediate act, in some cases, the data compliance application may generate and send a user identification request via the network to the relevant third-party data processors to verify that the third-party data processors have data stored about the user. Once confirmed, the data compliance application may generate and send a request to the third-party applications instructing them to permanently delete the data they have stored about the user.

Each third-party data processor processes its respective request and generates and sends a response back to the data compliance application indicating whether any of the user's data is present in its data store. Based on the response(s) received from the third-party data processor(s), the data compliance application requests that the third-party data processors that are storing the user's data delete the information stored about the user from their third-party data store(s). The data compliance application then automatically manages the deletion process with each third-party data processor to ensure the user data is deleted and remains deleted.

The technology may include various systems, methods, processes, computing apparatuses, computer program products, graphical user interfaces, and other aspects. One such system 100 for detecting third-party data tracking and generating and managing third-party data deletion requests is depicted in FIG. 1A. As shown, the system 100 may include one or more computing devices 104a, 104b . . . 104n (also referred to herein individually and/or collectively as 104), a data compliance server 110, a first-party server 120, and one or more third-party servers 131 (also referred to herein individually and/or collectively as 131), which are electronically communicatively coupled via a computer network 102 for interaction with one another.

As shown, the system 100 may include a client-server architecture, although a variety of different system environments and configurations are contemplated and are within the scope of the present disclosure, such as ones including additional or alternative devices, systems, and networks. For instance, various functionality may be moved from a server to a client, or vice versa, data may be consolidated into a single data store or further segmented into additional data stores, and some embodiments may include additional or fewer computing devices, services, and/or networks, and may implement various functionality client or server-side. Further, various entities of the system may be integrated into a single computing device or system or additional computing devices or systems, etc.

The network 102 may include any number of networks and/or network types. For example, the network 102 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, various combinations thereof, etc.

The network 102 may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols, or other known protocols.

The computing device(s) 104a . . . 104n, the data compliance server 110, the first-party server 120, and/or the third-party server(s) 131, and/or their components, may be wiredly or wirelessly coupled to the network 102. Various users, such as data compliance application 115 users (also called stakeholders), and first-party application 122 and third-party application 132 users (also called end-users or just users), may access various computing devices 104 to utilize the functionality of those applications.

A computing device 104 includes one or more computing systems having data processing and communication capabilities, such as the computing system 150 shown in FIG. 1C. In some embodiments, a computing device 104 may include a processor (e.g., virtual, physical, etc.), a memory, a power source, a communication unit, and/or other software and/or hardware components, such as a display, graphics processor, wireless transceivers, keyboard, camera, sensors, firmware, operating systems, drivers, various physical connection interfaces (e.g., universal serial bus (USB), high-definition multimedia interface (HDMI), etc.). The computing device 104 may couple to and communicate with other computing devices 104, the data compliance server 110, the first-party server 120, the third-party server(s) 131, and/or other entities of the computing system 100 via the network 102 using a wireless and/or wired connection.

Examples of computing devices 104 may include, but are not limited to, mobile phones, tablets, laptops, desktops, netbooks, server appliances, servers, virtual machines, TVs, set-top boxes, augmented reality devices, virtual reality devices, smartwatches, other wearable devices, implantable devices, etc. The system 100 may include any number of computing devices 104. In addition, the computing devices 104 may be the same or different types of computing devices.

The computing devices 104a . . . 104n may each include one or more instances of a client application 106a . . . 106n (also referred to herein individually and/or collectively as 106). A client application 106, also called a user application, may embody and/or include an instance of the first-party application 122 and/or the data compliance application 115. In some implementations, the client application 106 may comprise a browser application, such as a web browser (e.g., Microsoft Edge™, Google Chrome™, etc.) that is configured to load and operate multiple web-based client applications, as discussed further elsewhere herein, although other variations are also possible. For example, one or more instances of a client application 106 may comprise one or more dedicated native applications (e.g., apps).

In further implementations, multiple instances of a client application 106 may be installed and executing on a computing device 104. For example, a computing device 104 may have an instance of the first party application 122 (a first user application 106) and an instance of the data compliance application 115 (a second user application 106). For instance, the first-party application 122 may be client code downloadable from an application marketplace, such as an application storefront (e.g., Apple App Store™), and operable as a native client-side application that includes the features described herein. Other combinations or variations are also possible and contemplated.

The data compliance server 110, the first-party server 120, and/or the third-party server(s) 131 may each include one or more computer systems having data processing, storing, and communication capabilities. For example, the data compliance server 110, the first-party server 120, and/or the third-party server 131 may include one or more hardware servers, server arrays, storage devices and/or systems, etc. In some embodiments, data compliance server 110, the first-party server 120 and/or the third-party server 131 may include one or more virtual servers, which operate in a host server environment and access the physical hardware of the host server including, for example, a processor, memory, storage, network interfaces, etc., via an abstraction layer (e.g., a virtual machine manager). In some embodiments, data compliance server 110, the first-party server 120, and/or the third-party server(s) 131 may include a web server, a (representational state transfer) REST service, or other server type, having functionality for satisfying content requests and receiving content from one or more computing devices that are coupled to the network 102 (e.g., a computing device 104, etc.).

The data compliance server 110 may include a data compliance data store 111 and a data compliance application 115, which may comprise software and/or hardware logic executable to the perform various acts and functionality discussed herein with respect to the data compliance application 115. The data compliance application 115 may, in some implementations, include application programming interface(s) (API(s)) 116, a deleter 117, and a verifier 118.

The first-party server 120 may include a first-party data store 121 and a first-party application 122, which may comprise software and/or hardware logic executable to perform the various acts and functionality discussed herein with respect to the first-party application 122. The first-party application 122 may, in some implementations include one or more APIs 123. Each third-party server 131 may include a third-party data store 134 and a third-party application 132, which may comprise software and/or hardware logic executable to perform the various acts and functionality discussed herein with respect to the third-party application 132. The third-party applications 132a . . . 132n may, in some implementations include one or more APIs 133a . . . 133n (also referred to herein individually and/or collectively as 133).

An API includes any computing interface that provides for interaction between different software programs. The API may define the calls or requests that can be made, how to make them, and the data formats that may be required, etc. An API may be custom, specific, or designed based on accepted standards. An API may be formal or informal. An API may be interrogatable to determine its functionality, or its functionality may be documented. The API may be public or private, and may provide, extend, or facilitate web services, may be based on libraries or frameworks, may be local or remote, and/or have any other suitable attributes or functionality. An example API may be written in Python, JavaScript, or any other suitable language, and may support a variety of data formats (e.g., JavaScript Object Notation (JSON), eXtensible Markup Language (XML), other suitable formats), etc.

By way of example, the data compliance application 115 may expose the API(s) 116 to first and third-party applications 122 and 132. The API(s) 116 may include an API having methods that are configured to receive data deletion requests, provide updates on submitted data deletion requests, provide functionality for deleting submitted requests and/or resubmitting requests, and/or provide any other functionality described herein with respect to the data compliance application 115. For instance, a data deletion request from a first-party application 122 may be received via an API 116. The first-party application 122 may be registered with the data compliance application 115 to use the API(s) 116, and may use an API token or other credentials for securing communication, etc. In another example, the data compliance application 115 may interface with third-party applications 132 via the APIs 133 of those applications. For instance, user identification requests, third-party deletion requests, and/or other requests discussed herein may be sent to the third-party data processor via corresponding APIs exposed by those third-party applications 132.

The data compliance data store 111, the first-party data store 121, and the third-party data store(s) 134a . . . 134n (also referred to herein individually and/or collectively as 134) are information sources for storing and providing access to various data. The data compliance application 115 may be coupled to retrieve, generate, and/or store any applicable data in the data compliance data store 111; the first-party application 122 may be coupled to retrieve, generate, and/or store any applicable data in the first-party data store 121; and the third-party applications 132a . . . 132n may be coupled to retrieve, generate, and/or store any applicable data in the third-party data stores 134a . . . 134n, respectively.

In some implementations, the data compliance data store 111 may store vendor data 112 and compliance data 113, as discussed herein. The various data stored by the data compliance data store 111, the first-party data store 121, and the third-party data store(s) 134a . . . 134n may be organized and queried using various criteria including any type of data stored by them, such as unique identifiers, timestamps, textual and/or graphical content, entity characteristics, etc., as discussed in further detail herein. Any of the data compliance data store 111, the first-party data store 121, and the third-party data store(s) 134a . . . 134n may include data tables, relational/semi-structured/graph/etc., databases, key/value pair lists, or other organized or unorganized collections of data.

It should be understood that the system 100 illustrated in FIG. 1A is representative of an example system, and that a variety of different system environments and configurations are contemplated and are within the scope of the present disclosure. Other implementations may include additional or fewer computing devices, services, and/or networks. Further, various entities of the system may be integrated into a single computing device or system or additional computing devices or systems. For instance, other servers providing social networks, video communication services, e-commerce solutions, etc., may be included in the system.

FIG. 1B illustrates a data flow diagram 170 of the example system 100. As shown, the user 172 interacting with a user interface of the first-party application 122 may initiate a request to delete any user data that the first-party application 122 has collected about the user during his or her use of the first-party application 122 over time. Because a first-party application 122 uses third-party modules 181 to provide end-user functionality and/or track and/or process user interaction with the third-party application 132, the user data collected by the third-party data processors 130, which is represented as tracking data 177 in FIG. 1B, should be deleted in order to comply with privacy laws.

In particular, when a user loads the first-party application, such as a website, the website sends first-party app data 179 (e.g., data comprising the structure and content of the website) and includes embedded data 176, such as third-party modules 181 or widgets, are executed when loaded. As the user navigates the website, clicks on articles, clicks on advertisements, signs up for a newsletter, leaves comments, and/or performs other actions on the website, the third-party modules 181 collect and send tracking data 177 reflecting various user interactions with the website and requests for functionality to their respective third-party applications 132 for processing and storage as tracking data 177 in the third-part data store(s) 134 and/or reply. Similarly, first-party usage data 178 reflecting the user's interactions with the website is sent to the first-party application 122 in the form of requests, which the first-party application 122 processes and stores in the first-party data store 121, and/or responds to.

Over time, a first-party application 122 that has thousands of daily, weekly, or monthly visitors, collects a vast amount of user data about those users. When users request that their data be deleted, ensuring that third-party data processor(s) 130 delete the users' data responsive to each such request can be especially difficult to do because the first-party is unaware of how each third-party data processor 130 tracks or stores the user's data, and the user's data is typically spread out across numerous disparate, unidentified third-party data stores 134 operated by the third parties, to which the first party has no direct data connection and over which it has no direct control. Thus, the various instances of tracking data 177 stored in the various third-party data stores 134 are not conveniently indexed to a single identifier for a particular user.

To address this issue, the data compliance application 115 provides methods for enabling and automating the submission, processing, and managing of data deletion requests by users to any number of third-party data processors 130. By way of example, the data compliance application 115 uses an innovative approach to help ensure that the personal information associated with the user making the request is found and deleted using API(s) developed to interface with numerous different third-party vendors that a first-party application (e.g., a company) may use in its web application. A user can request that all of their personal information gathered by the first-party application 122 and its third-party vendors be deleted, or they can selectively request deletion of their personal information held by specific vendors. Any number of third-party vendors may be supported by the data compliance application 115 (e.g., hundreds, thousands, etc.)

Using these methods, users, via the first-party application 122 and/or another interface may submit user data deletion requests, reflected in the first-part deletion request data 173, for any of the third-party applications 132 used by the first-party application 122. As also reflected by data 173, responsive to receiving the requests, the data compliance application 115 may provide responses that provide for tracking and management of the data deletion requests.

FIG. 2 is a flowchart of an example method 200 for processing third-party data deletion requests. In some implementations, the method 200 may be initiated responsive to the data compliance application 115 receiving a data deletion request via a network 102 from a client application, where the data deletion request requests deletion of data about a user.

In block 202, the deleter 117 of the data compliance application 115 may determine the third-party data processor(s) that are to be requested to delete data stored about a given user.

In some implementations, for each such third-party data processor 130, the deleter 117 may request 204 confirmation that the third-party data processor 130 stores information associated with the unique user identifier (ID) associated with the user. For instance, the data compliance application 115 may send a user identification request via the network 102 to the third-party data processor 130. The user identification request may be a unique user identifier for the user and request confirmation that the third-party data processor 130 has stored information about the user in a third-party data store 134. In response, the deleter 117 may receive, via the network 102, a user identification response confirming that the third-party data processor 130 is storing the information about the user.

As a further example, the deleter 117 may send a request via the API 133 of the third-party application 132. The API 133 may expose a method that, if sent the user's unique identifier, will generate and send a response that includes a summary of the data that the third-party data processor 130 is storing about the user, or otherwise confirms that data about the user is present in the tracking data 177 stored in the third-party data store 134 of the third-party data processor 130. The deleter 117 may receive the response and determine, based on the data included in the response, whether the third-party data processor 130 is storing any data that requires deletion.

In block 206, if any user data is confirmed to be present/stored by the third-party data processor 130, the deleter 117 may proceed to request the deletion of the user's data from each relevant third-party data processor 130. In some implementations, the deleter 117 may proceed to request the deletion of the user's data without executing the operations in blocks 204 and 206, and may instead submit third-party data deletion requests without first requesting confirmation.

In some implementations, the deleter 117 may proceed to block 216 and generate and send, via the network 102, a third-party data deletion request to the third-party data processor 130 requesting that the third-party data processor 130 delete the information stored about the user in the third-party data store 134. The third-party data deletion request may include the unique user identifier so that the third-party data processor 130 can identify and delete the appropriate data from its third-party data store 134. In various instances, this may be performed responsive to receiving the user identification response or responsive to receiving a first-party data deletion request, a timer, or other programmatic logic.

In some further implementations, the deleter 117 may first proceed to block 212 and create a third-party deletion request record in the data compliance data store 111 and, in block 214, determine whether, for that particular third-party data processor 130, an API is available for automatically requesting deletion of the information that the third-party data processor 130 has stored about the user. For example, the deleter 117 may retrieve the profile (vendor data 112) for the third-party data processor 130 from the data compliance data store 111, and process the profile to determine, based on the defined parameters, if the third-party data processor 130 has an API available for deleting the user's data. An example API call may require an API key, an organization ID, a token secret, and/or other suitable parameters for connecting to and requesting deletion of the user's data.

If, in block 214, the determination is that a deletion API is not defined for the third-party data processor 130, then, in block 224, the deleter 117 may submit a semi-automated or manual request to the third-party data processor 130. In an example semi-automated implementation, the third-party data processor 130 may provide a request form for submitting a data deletion request (e.g., send form data including the user's email address to a dedicated email address of the third-party data processor 130), but may lack automated functionality for tracking the status of the data deletion request or confirming whether the request was successfully completed. The deleter 117 may automatically submit, via the request form, a data deletion request to the third-party data processor 130, and may then follow up by email, phone, or other methods to confirm whether the request was completed. In an example manual implementation, the data compliance application 115 may utilize manual methods for submitting and confirming completion of the data deletion request.

If, in block 214, the determination is that a deletion API is defined for the third-party data processor 130, the deleter 117 may, in block 216, generate and send, via the network 102, the third-party data deletion request as described above.

In block 218, the data compliance application 115 may receive, via the network 102 from the third-party data processor 130, a third-party data deletion response including a transaction identifier for the third-party data deletion request. The third-party data deletion response may include other information, such as a status for the data deletion request. In some implementations, the third-party data processor 130 may be capable of immediately deleting the information it has stored about the user, may delete it immediately from its third-party data store 134, and provide a status confirming such (e.g., status is “complete”) in the third-party data deletion response. In further implementations, the third-party data processor 130 may take some time to delete the information it has stored about the user, and may provide an appropriate status in the third-party data deletion response (e.g., status is “pending”). In some further implementations, an anomaly may occur during the data deletion request process and the third-party data processor 130 may return a third-party data deletion response with an error status. The error status may include information about the error, such as an error code, error description, etc., and/or an indication of whether the data deletion request should be (re)submitted. Other implementations are also possible and contemplated.

The data compliance application 115 may process the response from the third-party data processor 130 in block 218 to determine various information about the data deletion request, such as to determine the transaction ID in block 220.

In block 222, the deleter 117 may update the deletion record in the data compliance data store 111 to include the information, such as the transaction ID, the status, a timestamp for the third-party data deletion request, any manual updates, and/or any other suitable information, etc.

The deleter 117 may return to block 208 and determine whether all third-party data processors 130 associated with the first-party/user data deletion request were processed. If not, the deleter 117 may return to block 202 or 216, as the case may be, to initiate the data deletion process with the remaining third-party data processors 130. While the method 200 is shown as being a serial process, it should be understood that the various operations may be performed in parallel, such as confirming whether each third-party data processor 130 is storing information about the user, and initiating the data deletion process with each third-party data processor 130.

If all third-party data processors 130 have been processed, the method 200 may end as shown in block 210, or may proceed to other operations, such as those discussed elsewhere herein.

In some implementations, to facilitate the submission of the user data deletion requests, the first party application 122 may include a privacy manager 180, which may comprise software logic executable to determine the various unique third-party user identifiers being used by third-party data processors 130 to index the user's data. In some implementations, the unique third-party user identifiers may be identified using the method 500 depicted in FIG. 5A. As shown, in block 502, the first-party application 122 may present a deletion request user interface for interaction by the user. In block 504, the first-party application 122 may receive, via the deletion request user interface, input requesting deletion of any data that the first-party application 122 has collected about the user. In block 506, the privacy manager 180 of the first-party application 122, responsive to receiving the input requesting the deletion of the user's data, may determine the unique user identifiers associated with the third-party data processors 130.

As a further example, the privacy manager 180 may determine a plurality of third-party data processors 130 associated with a web site loaded in the client application 106 of the user. The privacy manager 180 may provide a user interface for presentation to the user, such as those discussed with reference to FIGS. 6A-6C, that including a plurality of user-interactable elements for interacting with the plurality of third-party data processors, such as selecting or deselecting the third-party data processors 130 for inclusion in a data deletion request. The privacy manager 180 may receive input via an input device 158 of the computing device 104 of the user. The input may select the third-party data processor(s) via corresponding user-interactable element(s) included in the user interface.

In some implementations, the privacy manager 180 may use profile data of the third-party data processor(s) 130 and tracking data to determine the unique user identifier(s) and generate data deletion request(s), as shown in FIG. 5B. In block 512 of the method 510 depicted in FIG. 5B, the privacy manager 180 may determine the profile data of third-party data processor(s) 130, and in block 514, the privacy manager 180 may retrieve third-party tracking data associated with the user from a local memory of the computing device 104 of the user.

In some implementations, profile data of the vendors/third-party data processors 130 that the first-party uses in its first-party application 122 may be defined and stored as vendor data 112 in the data compliance data store 111. To determine the profile data, the privacy manager 180 may send a request to the data compliance application 115 requesting that the data compliance application 115 provide the profiles of the third-party data processors 130 that are associated with the first-party application 122 in the vendor data 112 stored in the data compliance data store 111. For example, the privacy manager 180 may generate and send a request that includes a unique identifier for the first-party application 122, to an API 116 of the data compliance application 115 requesting that the profiles of the third parties associated with the unique identifier of the first-party application 122 be provided.

The data compliance application 115, responsive to receiving the profile data request, may query the vendor data 112 stored in the data compliance data store 111 using the unique identifier for the first-party application 122. Responsive to executing the query, the data compliance application 115 may retrieve the vendor data 112 associated with the first-party application 122 then send it to the privacy manager 180.

In block 516 the privacy manager 180 may determine, using the profile data of the third-party data processor(s) 130, that the third-party tracking data includes unique user identifier(s) that the third-party data processor(130) use to uniquely identify the user, and track the user's online behavior and/or information.

By way of example, a user identifier used by a given third-party data processor 130 to track the user may be stored within the user's browser document object model (DOM), as cookie data in a database file stored in the memory of the user's computing device 104, in a profile folder in the memory of the user's computing device 104, in a local cache, or another repository. Each third-party data processor 130 may store the user's unique identifier using a specific variable name, which is reflected in the vendor profile data for that third-party data processor 130. The profile data may be retrieved and provided by the data compliance application 115 to the privacy manager 180, and the privacy manager 180 may use it to retrieve the appropriate identifier-storing variables of the relevant third-party data processors 130. For instance, the privacy manager 180 may search one or more of the above-noted local repositories for the third-party identifiers specifically associated with the user. E.g., the privacy manager 180 may use keywords, such as terms, identifiers, tags, etc., and search for database entries, DOM elements, and/or files that include and/or match the keywords, and may then parse the matching items for the unique identifiers.

By way of further example, the first-party application 122 may embed the following code to embed the privacy manager 180 as a widget in its webpage:

//Widget
_{——}rivn_account_id=’wBM7c5byzt’
function _{——}rivn_openPrivacyWidget( ){

_{——}rivn_widget=document.createElement(’SCRIPT’);
_{——}rivn_widget.type='text/javascript’;
_{——}rivn_widget.id=’_{——}rivn_modal’;
_{——}rivn_widget.src=’https://static.rivn.com/javascript/rivn.js';
_{——}document.getElementsByTagName(’head’)[0].appendChild(_{——}rivn_widget);

}

Responsive to the unique user identifier(s) used by the relevant third-party data processors 130 being determined in block 516, in block 518, the data compliance application 115 may generate corresponding third-party data deletion request(s) that include the appropriate unique user identifier(s). In some implementations, this may be responsive to the user submitting a request via the privacy manager 180 to the data compliance application 115, which in turn generates the third-party data deletion requests. In some further implementations, the data compliance application 115 may be configured to automatically request the third-party data processors 130 delete the user's data (e.g., without the intervening user data deletion requests). Numerous other variations are also possible.

In an implementation where a user data deletion request is submitted, the privacy manager 180 may present various corresponding interfaces, such as those depicted in FIGS. 6A-6C. As shown in FIG. 6A, the graphical user interface 600 may include a content region 602 that includes a list of all the third-party data processors 130 that have potentially processed the user's data. From the list, the user may individually select to initiate a data deletion request requesting that a given vendor delete his or her data. For example, the user may, using an input device 158 of his or her computing device 104, select user-selectable option 604 or 606 to request that vendor A or vendor N delete any information that that third-party data processor 130 has stored about him/her. Further, a user may select item 603 to initiate a data deletion request to all third-party data processors 130 to request that each vendor listed delete any information that they have stored about him/her. Other options for initiating data deletion requests are also possible and contemplated.

In response to the user selecting to initiate one or more data deletion requests, the privacy manager 180 may generate and display corresponding graphical user interfaces for submitting the request(s). For example, responsive to selecting item 603 in FIG. 6A to initiate data deletion request to all third-party data processors 130, the privacy manager 180 may expand a corresponding content region to display form 654 for submitting the request, although it should be understood that other user interfaces and elements may be used provide the same or similar functionality. In the depicted example, the form 654 may include one or more form fields for submitting the request, such as a request type, the country in which the request was originated, the state in which the request was originated, the first and last name of the requester, and an electronic address (e.g., email address, mobile phone number, etc.) of the requester, etc. The contact information depicted in this example may be used by the data compliance application 115 to keep the requester inform about the status of the data deletion request, as discussed elsewhere herein.

The user may select to submit the request by selecting a corresponding graphical user interface element, such as the submit button 656, using an input device 158 of the user's computing device 104. Responsive to receiving the selection, the privacy manager 180 may display a confirmation to the user that the request was successfully submitted, as shown in graphical user interface 660 depicted in FIG. 6C. The graphical user interface 660 may include a request identifier 662 for the data deletion request, which the user may record for his or her records and may use to track the status of the user data deletion request. Some embodiments, the request ID for the user data deletion request may be generated by the privacy manager 180 and/or the data compliance application 115. For example, the privacy manager 180 may request the data compliance application 115 provide the request ID responsive to receiving the user data deletion request from the privacy manager 180, and then the privacy manager 180 may display the request ID in the graphical user interface 660, although other variations are also possible and contemplated.

Additionally, the privacy manager 180 may generate and send the user data deletion request to the data compliance application 115. The privacy manager 180 may include the data provided in form 654, a unique ID for the first-party application, and/or the vendor IDs of the relevant third-party data processors 130 in the user data deletion request. In another example, the privacy manager 180 may include a flag indicating that all third-party data processors 130 associated with the first-party application 122 and the vendor data 112 stored in the data compliance data store 111 should be requested to delete the user's data, in which case the user data deletion request may include the unique identifier associated with the first-party application 122, which the data compliance application 115 may use to retrieve the appropriate third-party data processor 130 profiles from the vendor data 112 stored in the data compliance data store 111. While the foregoing provides an example of the user requesting to have all user data deleted from all vendors associated with the first-party application 122, it should be understood that any number (one or more) of third-party data processors 130 may be associated with the user data deletion request.

Responsive to receiving the user data deletion request, the data compliance application 115 may store the request and/or information from the request in the data compliance data store 111 as compliance data 113. Additionally, responsive to receiving the data deletion request, the data compliance application 115 may proceed to generate corresponding third-party data deletion request(s) based on the vendor IDs included in the data deletion request received from the privacy manager 180, as discussed further elsewhere herein.

Advantageously, using the privacy manager 180 allows an end-user, without interaction with an employee of the company, to independently: see which third-party vendors may have received personal data of the user from the first-party/company; send a deletion request to some or all of the third-party vendors which may have the user's personal data; and check on the status of the user's deletion request(s). Further, the privacy manager 180 advantageously automates the complicated process of finding an end user's known or anonymous identifiers that are stored in the browser various repositories, as discussed elsewhere herein.

The privacy manager 180 may also include user-selection options to allow a user to download and view the vendor data that each vendor has stored about them, which the data compliance application 115 may request from the third-party data processors 130, receive, and transmit to the client application 106 of the user. The privacy manager 180 may further allow the end-user to selectively delete some of the data while allowing the vendor to keep other aspects of the personal data so the vendor may improve its services or provide benefits, such as payments or discounts.

The list of third-party data processors 130 associated with a given first-party application 122, such as those depicted in FIG. 6A, may be defined by a first-party user, also called stakeholder, of the first-party application 122 using corresponding functionality provided by the data compliance application 115. In some implementations, as depicted in FIGS. 8A-8C, the data compliance application 115 may generate and provide for display vendor graphical user interfaces that provide an ability for a stakeholder of a first-party application 122 to define and manage the vendors/third-party data processors 130 that the first-party application 122 utilizes to process data. By way of example, a stakeholder may interact with the graphical user interfaces provided by the data compliance application 115 to see the status of the deletion requests that have been made by them or their users. The graphical user interfaces can present a general overview of the status of requests over time along with a few current requests and at least some of the third-party vendors used by that company. It can also provide an interface for reviewing the individual requests with the ability to drill down to see all the detail about a given request.

In particular, FIG. 8A depicts a graphical user interface 800 for a stakeholder of a first-party application to manage existing third-party data processors and adding new third-party data processors. As shown, a stakeholder may enable and disable existing third-party data processors (e.g., vendors A . . . N) using the user-selectable elements 802 (e.g., toggles). For instance, to disable vendor A, a stakeholder may select the corresponding toggle for vendor a to disable it, and later to reenable it, the stakeholder may reselect the corresponding toggle. The stakeholder may delete vendors using the user-selectable elements 804 (e.g., buttons), and may add a new vendor by selecting user-selectable element 801 via an input device of the computing device of the user.

Responsive to selecting to add a vendor, the data compliance application 115 may generate and provide for display the graphical user interface 810 depicted in FIG. 8B. In particular, the data compliance application 115 may retrieve a set of available third-party data processors 130 stored as vendor data 112 in the data compliance data store 111 and use it to generate the graphical user interface 800. As shown in FIG. 8B, a content region 811 may include the list 812 of available third-party data processors 130. A stakeholder may utilize the user-interactable components comprising search and filter options 816 to narrow the list 812 of available third-party data processors 130 according to certain criteria, such as processors managing certain keywords, categories, etc. For instance, upon selecting item 817, the data compliance application 115 may filter the list 812 in the content region 811 to show only the third-party data processors 130 that provide analytics functionality, and so forth.

A stakeholder may select to add a given vendor from the list 812 of third-party data processors 130 by selecting a corresponding user-interactable graphical element. For example, a stakeholder may, using his or her input device, select button 813, and responsive to receiving a selection, the data compliance application 115 may display graphical user interface 820, as depicted in FIG. 8C. Similarly, in FIG. 8A, a user may select button 801 to trigger the display of the same interface.

The graphical user interface 820 includes user-interactable elements for a user to define the attributes of the third-party data processor 130. As shown, the graphical user interface 810 includes a content region 821 that has a plurality of vendor configuration form fields 822 for defining the parameters for connecting to the third-party API of the third-party data processor 130 (which in this example is the Adobe Advertising Cloud API). Example form fields 822 may include a title text box 822a, an API key (also known as a client ID) text box 822b, a technical account ID text box 822c, an organization ID 822d, a client secret 822e, and a namespace 822f. The data compliance application 115 may assign a unique identifier to the profile of the third-party data processor 130, such as unique vendor identifier 826.

The content region 821 may also include custom configuration parameters setting options 824, such as variables that can be used by the privacy manager 180 to process the data used by a given third-party data processor 130 to track users (e.g., the unique user identifier used by the third-party data processor 130), and/or further parameters needed to properly connect to the third-party data processor 130 API. By way of example, a stakeholder can define different variable types and values using the fields 824a and 824b, and submit a defined variable by selecting the add variable button 824c. While not depicted, user-selectable options for deleting and editing already defined variables may also be included in the user interface 810.

The stakeholder may save a third-party data processor 130 profile by selecting a corresponding graphical user element, such as the “save” button 828. Upon submission, the client-side instance of the data compliance application 115 (e.g., the client application 106, a webpage loaded thereby, etc.) may send the profile data including the information defined in the user interface 820 to the server-side instance of the data compliance application 115, which may store the profile data defined in the graphical user interface 810 as vendor data 112 in the data compliance data store 111 in association with the unique vendor identifier 826 and an account of the stakeholder/first-party. In this way, the data compliance application 115 may independently manage (e.g., edit, delete, archive, add, etc.) each third-party data processor 130 records for each first-party that uses it to manage data compliance.

By way of further example that illustrates an example use of the third-party APIs 133, the vendor profiles stored in the data compliance data store 111 may constitute a plurality of third-party API profiles that are respectively associated with a plurality of third-party applications that the first-party application 122 relies upon. The data compliance application 115 may use the API profiles to automatically submit deletion requests to the third-party data processors 130. For example, the data compliance application 115 may receive a data deletion request via the network 102 and the first-party application (which requests deletion of data about a user), and may retrieve, from the data compliance data store 111, the plurality of third-party API profiles associated with the first-party application 122. The data compliance application 115 may then generate, for each third-party application 132, a corresponding a third-party data deletion request based on a corresponding third-party API profile and send each request via the network 102 to the corresponding third-party application 132 via a corresponding API of the third-party application 132. In reply, the data compliance application 115 may receive, via the network, a third-party data deletion response from each third-party application 132 (which includes a corresponding transaction identifier) and may update a data deletion record to include the transaction identifier and a timestamp for each third-party data deletion request.

Referring again to the data flow diagram 170 depicted in FIG. 1B, the data compliance application 115 may include a client-side instance of the data compliance application 115 that allows a stakeholder 171 of the first-party application 122 to manage the user data deletion requests received by the data compliance application 115 and the third-party deletion requests sent to the third-party data applications 132 in association with the first-party application 122, as reflected by the management data 174 and the third-party deletion request data 175 exchanged between them. The data compliance application 115 may store data associated with the receipt, processing, and management of any first and third-party requests in the data compliance data store 111 as discussed further elsewhere herein.

FIG. 3 is a flowchart of an example method 300 for verifying the third-party deletion of user data. By way of example, for an interval after receipt of third-party data deletion response(s), such as one received in block 218 of method 200, the verifier 118 of the data compliance application 115 may send verification request(s) to the third-party applications 132 requesting status updates on the deletion request(s). For example, responsive to receiving a third-party deletion response, the verifier 118 may send, via the network 102, periodic status request(s) to the third-party data processor 130. A periodic status request may include the transaction ID and may request confirmation from the third-party data application 132 that the information stored about the user was successfully deleted from the third-party data store 134. In a successful implementation, the verifier 118 may receive in reply, via the network 102 from the third-party data processor 130, a completion response including the transaction identifier and data verifying that the information stored about the user was deleted from the third-party data store 134, and may update, in the data compliance data store 111, the data deletion record associated with the first-party and the third-party. The update may include data reflecting that the third-party data deletion request was successful and a completion timestamp.

More particularly, in block 302, the verifier 118 initializes the deletion verification for a given transaction ID. The transaction ID may reflect a data deletion transaction for a given third-party data processor 130. For example, responsive to receiving a first-party/user data deletion request, the verifier 118 submitted a third-party data deletion request with a third-party data processor 130, as discussed elsewhere herein. Responsive to submitting the third-party data deletion request, the verifier 118 may have generated or received a unique transaction ID that corresponds specifically to the third-party data deletion request with that third-party data processor 130. The transaction ID may be stored in the deletion record associated with that third-party data deletion request in the data compliance data store 111 (e.g., as compliance data 113).

In block 304, based on the transaction ID, the verifier 118 may determine the third-party data processor 130 associated with the transaction ID. In some implementations, in determining the third-party data processor 130, the verifier 118 may retrieve the profile of the third-party data processor 130, which may include the parameters needed to initiate a data connection to the third-party data processor 130, such as a uniform resource locator (URL), an API key, an account ID, and/or any other parameters that are needed, as discussed elsewhere herein.

In block 306, the verifier 118 may generate and send a status request with the request transaction ID to the relevant third-party data processor 130, and in block 308, responsive to sending the request in block 306, the verifier 118 may receive a status response for the transaction ID. The status response may reflect a processing status of the third-party data deletion request associated with the transaction ID that was previously submitted to the third-party data processor 130. The status response may include a timestamp of response, a status identifier, status description, and/or any other information associated with the processing of the third-party data deletion request associated with the transaction ID. An example may include a status code (e.g., any arbitrary code, HTTP code, etc.), a status descriptor (e.g., in progress, error, etc.), a status description (e.g., “Request No: X18YfwLp5gnqW still being processed.”), etc.

In block 310, based on the status response, the verifier 118 may determine whether the data deletion request associated with the transaction ID was successfully processed. If not, the verifier 118 may determine in block 314 if the deletion request failed based on the status response. For example, the status response may include an indication that the third-party application 132 failed to delete the information that the third-party data processor 130 has stored about the user. For instance, the status response may indicate that an error occurred in the submission of the third-party data deletion request, in the deletion of the user data, etc.

If the determination in block 314 is affirmative, the verifier 118 may, in block 318, update the deletion record in the data compliance data store 111 to reflect the failure, and may generate and send a notification to the client device of the stakeholder in block 320. The notification may provide information reflecting the failure, such as an error code, descriptor, description, reason, etc. Upon receipt, the stakeholder may interact with the verifier 118 to resubmit the request, debug the error, or take another action to address the failure.

If the determination in block 314 is negative, the verifier 118 may, in block 316, wait for the next verification iteration to provide time for the third-party data processor 130 to delete the user's data, and then repeat the operations of method 300 to verify the deletion of the user's data.

Returning to block 310, if the response received in block 308 confirms that the information stored about the user has been deleted from the third-party data store, then the verifier 118 may update the deletion record stored in the data compliance data store 111 as compliance data 113 to reflect the successful processing of the data deletion request.

For example, the status response may indicate that the information that the third-party data processor 130 had stored about the user has been successfully deleted from the third-party data store 134, and the verifier 118 may update the deletion record to reflect the timestamp associated with the successful deletion of the user's data, and include any other information from the status response, such as data reflecting that the third-party data deletion request was successful.

In block 313, the verifier 118 may generate and send an electronic confirmation notification reflecting that the information stored about the user was deleted from the third-party data store. The electronic confirmation notification may be sent for presentation to the user to inform the user that the information that the third-party data processor 130 stored about the user was deleted. In some implementations, the verifier 118 may send the electronic notification to an electronic address of the user via the network 102. Any notification described herein may be provided to the user using any suitable notification mechanism, such as by generating and sending an e-mail, text message, push notification, an in-application notification (such as one presented in an interface by the first-part application 122, etc.), etc., although any other suitable notification method may be applicable and is contemplated.

Advantageously, upon receiving a completion response indicating that the information stored about a given user was deleted by the third-party data processor 130, the data compliance application 115 may automatically verify that the information stored about the user remains deleted. For example, the data compliance application 115 may have received, via the network 102 from the third-party data processor 130, a completion response including the transaction identifier and verification data verifying that the information stored about the user was deleted from the third-party data store, such as in block 218 of method 200 or block 308 of method 300, and may update the data deletion record in the data compliance data store 111 to reflect the successful deletion an include a completion timestamp.

Then, for an interval beginning after receipt of the completion response, the verifier 118 may send, via the network 102, a periodic compliance request to the third-party data processor 130. For example, FIG. 4 depicts a method 400 for data deletion compliance. In block 402, the verifier 118 may initiate deletion compliance for a transaction ID/third-party data deletion request. In block 404, the data compliance application 115 may determine the third-party data processor 130 in the same or similar to that described with respect to block 304 in FIG. 3.

In block 406, the verifier 118 may request user data associated with the unique user ID of the user that initially requested deletion of the data. This user data request may represent a periodic compliance request, and may include the unique user identifier and request a subsequent confirmation confirming whether any portion of the information about the user has reappeared in the third-party data store. In some implementations, the user data request may be the same or similar to that of the request submitted in block 204 or block 216.

Responsive to sending the request, in block 408, the verifier 118 may process the response received from the third-party data processor 130, and in block 410, may determine whether the user data reappeared. For example, the response received in block 406 may represent a compliance response reflecting that at least a portion of the information about the user that reappeared in the third-party data store. If the user data reappeared, then the third-party data processor 130 did not permanently delete the user data, and the data compliance application 115 may initiate a subsequent iteration of the data deletion process of the method 200 to delete the at least the portion of the information about the user that reappeared in the third-party data store. For instance, the data compliance application 115 may submit another third-party data deletion request to the third-party data processor 130 using the data deletion process 231 embodied by the blocks 212-222 and 224 and as described with reference to FIG. 2.

If in block 410, the verifier 118 determines that the user data has not reappeared, then, in block 414, the verifier 118 may update the deletion record to reflect continued compliance.

The intervals at which the verifier 118 performs data deletion verification reflected in method 300 and data deletion compliance reflected in method 400 may be variable or user-defined. The total interval timeframe may extend for days, weeks, months, or a year, and the periodicity with which the data compliance application 115 interrogates the third-party applications 132 to verify data deletion or deletion compliance may be fixed, variable, user-defined, or have some other suitable definition. By way of example, the verifier 118 may send verification and compliance requests on a daily, weekly, monthly, yearly, etc., basis, as is needed to help ensure compliance and meet requirements. Eventually, after a sufficient amount of time has passed, the verifier 118 may update the data deletion record corresponding to the user data deletion request to reflect the final outcome of the data deletion and compliance.

Responsive to an interval ending, the verifier 118 may determine that a verification or compliance criterion is satisfied, and generate an electronic notification reflecting such (e.g., that the information stored about the user successfully was deleted or purged from the third-party data store). An example, compliance criterion may include a compliance duration, such as a period of time during which the third-party data processors 130 must be deemed compliant with the data deletion requests (e.g., not have the user's data resurface). An example duration may be any number of days, months, a year, years, etc. For example, the criterion may be a year of compliance from submission of the request.

The verifier 118 may send the electronic notification to an electronic address of the user via the network 102. Once all third-party data deletion requests are determined to be complete and the compliance process for confirming that the user's data remained deleted, the data compliance application 115 and may purge any user-identifying data associated with the user's data deletion request, such as the data associated with the user's data deletion request, the third-party data deletion requests sent to the third-party data processors 130, and the responses received from the third-party data processors 130. In some implementations, the data compliance application 115 may retain a requisite amount information to account for the fact that the data deletion was performed, such as the user data deletion request ID, the third-party transaction IDs, etc.

FIGS. 7A-7D illustrate example user interfaces for managing the data deletion compliance process. In particular, in FIG. 7A, the graphical user interface 700 depicts a dashboard for first and third-party data deletion requests and vendors. As shown, the graphical user interface 700 may include user-selectable options for viewing and interacting with requests that are at different stages, such as accessing new requests, accessing outstanding requests awaiting input from users, accessing requests that are ready to process, and viewing requests that are in process. The dashboard may include one or more data visualizations to visualize request stages in the items pending action by users or the stakeholder. A stakeholder may select a corresponding graphical element to access any of the depicted requests or vendors. For example, a stakeholder may select to access a request or vendor so that the stakeholder may view additional information about the requester vendor, configure the request or vendor, delete the request or vendor, or take some other action. For instance, responsive to the selection of interface element 702, which corresponds to accessing a requests user interface, the data compliance application 115 may provide the user interface 710 depicted in FIG. 7B for display, and responsive to the selection of interface element 704, which corresponds to accessing a vendors user interface, the data compliance application 115 may provide the user interface 800 depicted in FIG. 8A for display.

The user interface 710 depicted in FIG. 7B is a user interface for accessing existing user data deletion requests. In the depicted implementation, user interface 710 includes three request entries 712, request 712a, request 712b, and request 712c, although it should be understood that any suitable number of requests at any suitable stage of processing may be included. In this example, request 712a is a new request that was recently received, request 712b is a request that was previously received and is awaiting user confirmation, and request 712c is received user confirmation and is currently being processed. As reflected by request 712a, when new data deletion request is received by the data compliance application 115, the data compliance application 115 may require that may verify that the request is authentic and authorized by executing the method 730 depicted in FIG. 7E.

In some implementations, a stakeholder may select a select all option 713 along with an action from the action menu 714 to initiate bulk operations on the requests. For example, a stakeholder can instruct the data compliance application 115 to progress each request to an applicable next stage (e.g., confirm request->confirm user->request status or resubmit request, etc.), by selecting a process next step option 714a. Further, a stakeholder may select to expand a request entry, such as the request 712a entry, by selecting an expansion/accordion graphical element, such as element 715a.

Responsive to selecting element 715a, the data compliance application 115 may update the graphical user interface 710 as shown in FIG. 7C. The expanded request 712a entry may include a request details content region 716a including detailed information about the data deletion request such as the details about the user 718, third-party data processors information 719 showing information about the third-party data processors 130 that will be requested to delete the personal data of the user, and a detailed status indicator 717 that indicates any actions that are being awaited or that require execution. For example, the detailed status indicator 717 may indicate that the entry is “Waiting for Customer,” which reflects that a confirmation request has been sent to the user and the data compliance application 115 is awaiting receipt of a confirmation response authorizing the data deletion request.

In FIG. 7D, request 712c entry is shown in expanded form (e.g., responsive to the selection of expanding option 715c in FIG. 7B) to illustrate an expandable request details content region 716c (which may include information similar to that described with reference to content region 716a but pertinent to 712c entry), and a processing details content region 720, which may be made available by the data compliance application 115 for requests that have reach the processing stage in which third-party data deletion requests have been submitted.

As shown, the processing details content region 720 includes entries 722a, 722b, and 722c for three example third-party data processors 130, Vendor A, Vendor B, and Vendor C. As shown by entry 722a, the user data deletion request was received, data was found in vendor's dataset and was successfully deleted on Nov. 4, 2019, and since then periodic (monthly) compliance requests were submitted to verify the personal data of the user has remained deleted from the vendor's dataset.

In entry 722b, the user data deletion request was received, data was found in vendor's dataset and was successfully deleted on Nov. 4, 2019, but since then data reappeared in the vendor's dataset and had to be subsequently deleted. The data compliance application 115 caught this issue by sending the periodic status/compliance requests.

In entry 722c, the user data deletion request was received, data was found in vendor's dataset but was unsuccessfully deleted on Nov. 3, 2019. The data compliance application 115 attempted to resubmit the third-party data deletion request on Nov. 4, 2019, but that too failed. The stakeholder viewing the audit trail may select to resubmit the third-party data deletion request to the third-party data processor 130 by selecting the resubmit user interface element 724, may delete the request, may edit the vendor profile to correct, the issue, select a user interface option 726 to view the log and debug the issue, the selection of which may display a corresponding user interface or content region for viewing the log, etc. In some implementations, the options 726 and 724 may be presented responsive to detecting an issue with a third-party data deletion request, although other variations are also possible and contemplated.

FIG. 7E is a flowchart of an example method 730 for verifying that a data deletion request is authorized. In block 731, the data compliance application 115 may generate and send a confirmation notification to the electronic address of the user that submitted the data deletion request. For example, as discussed with respect to FIG. 6B, a user data deletion request may include contact information, such as the electronic address of the user, which may be used by the data compliance application 115 generate and send the request confirmation notification.

In block 732, the data compliance application 115 may receive a response from the electronic address of the user consenting to the third-party data deletion request(s) that are to be submitted as part of the processing of the user data deletion request.

In block 733, the data compliance application 115 updates the data deletion record stored in the data compliance data store 111 (e.g., as compliance data 113) to reflect the third-party data deletion request has been consented to by the user.

Referring again to FIG. 1C, the example computing system 150 may represent the computer architecture of a user's or stakeholder's computing device 104 (also referred to as a client device), a data compliance server 110, a first-party server 120, and a third-party server 131. A computing device 104, a data compliance server 110, a first-party server 120, or a third-party server 131 may include different software or hardware components depending on the implementation.

Thus, any of the computing device 104, the data compliance server 110, the first-party server 120, or the third-party server 131 may be represented by the computer system 150 and include a communication unit 152, one or more processors 154, one or more memories 156, one or more input devices 158, and one or more output devices 160. As shown, the communication unit 152, the processor(s) 154, the memory/ies 156, the input device(s) 158, and the output device(s) 160 may be electronically communicatively coupled by a communication bus 151.

The communication bus 151 may include a bus for transferring data and signals between components of a computing system or between computing systems, a network bus system including the network 102 or portions thereof, a processor mesh, a combination thereof, etc. In some implementations, the data compliance server 110, the third-party server(s) 131, the first-party server 120, and/or the computing device(s) 104 may cooperate and communicate via a communication mechanism included in or implemented in association with the bus 151. The software communication mechanism may include and/or facilitate, for example, inter-method communication, local function or procedure calls, remote procedure calls, an object broker (e.g., common object request broker architecture (CORBA)), direct socket communication (e.g., TCP/IP sockets) among software modules, UDP broadcasts and receipts, HTTP connections, etc. Further, any or all of the communication could be secure (e.g., secure shell (SSH), HTTPS, etc.).

A communication unit 152 may include one or more interface devices (I/F) for wired and wireless connectivity among the components of the system 100. For instance, the communication unit 152 may include various types known connectivity and interface options. Wireless (e.g., Wi-Fi®) transceivers, Ethernet adapters, and modems, are just a few examples of interface devices.

A communication unit 152 may be coupled to the other components of the computing system 150 via the bus 151. The communication unit 152 may be electronically communicatively coupled to the network 102 (e.g., wiredly, wirelessly, etc.). In some implementations, the communication unit 152 can link the processor(s) 154 to the network 102, which may in turn be coupled to other processing systems. The communication unit 152 can provide other connections to the network 102 and to other entities of the system 100 using various standard communication protocols.

The processor(s) 154 may have various computing architectures to method data signals including, for example, a complex instruction set computer (CISC) architecture, a reduced instruction set computer (RISC) architecture, and/or an architecture implementing a combination of instruction sets. The processor(s) 154 may be physical and/or virtual, and may include a single core or plurality of processing units and/or cores.

A processor 154 may execute software instructions, such as the operations, acts, and functions described herein, by performing various input, logical, and/or mathematical operations. For example, operations performed by a computing device including “processing,” “computing,” “retrieving,” “calculating,” “determining,” “displaying,” or others identified in the methods described herein, may refer to the action and processes of the computing system 150, or similar electronic computing device, that manipulates and transforms data represented as physical (electronic) quantities within the computer system's registers and memories into other data similarly represented as physical quantities within the computer system memories or registers or other such information storage, transmission or display devices.

In some implementations, a processor 154 may be capable of generating and providing electronic display signals to a display device, supporting the display of images, capturing and transmitting images, performing complex tasks including various types of feature extraction and sampling, etc. In some implementations, the processor(s) 154 may be coupled to the memory/ies 156 via the bus 151 to access data and instructions therefrom and store data therein. The bus 151 may couple the processor(s) 154 to the other components of the computing system 150 including, for example, the communication unit 152, the memory/ies 156, the input device(s) 158, the output device(s) 160, and/or any other components, such as other suitable components and/or computing systems.

The memory/ies 156 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor(s) 154. In some implementations, the memory/ies 156 may include one or more of volatile memory and non-volatile memory (e.g., read-only memories (ROMs), random access memories (RAMs), erasable programmable ROMs (EPROMs), electrically erasable programmable ROMs (EEPROMs), flash memories, solid-state memories, hard disks, magnetic or optical cards, optical disks, etc.), or any other type of media suitable for storing electronic instructions and/or data. It should be understood that the memory/ies 156 may be a single device or may include multiple types of devices and configurations.

A memory 156 may store instructions and/or provide access to data to the other components of the computing system 100, such as instructions and/or data that may be executed by the processor(s) 154. For example, one or more memories 156 may store an instance of the data compliance application 115, a third-party application 132, and/or a first-party application 122, and their respective components, depending on the configuration. For instance, the memory/ies 156 of a computing device 104 of an end-user that interacts with the interfaces of the first-party application may store an instance of the first-party application 122 and one or more instances of the third-party application(s) 132.

In another example, the memory/ies 156 of a client device 104 of a stakeholder of the first-party application 122 may include an instance of the data compliance application 115 so the stakeholder can a manage inbound and ongoing first-party and third-party data deletion requests, such as one submitted by the foregoing end-user via an interface of the first-party application. In further examples, the memory/ies 156 of the third-party server 131 may store an instance of the third-party application 132 and may store the data of the third-party data store 134, such as the personal data of users; the memory/ies 156 of the data compliance server 110 may store an instance of the data compliance application 115 and may store the data of the data compliance data store 111, such as the vendor data 112 and the compliance data 113; and the memory/ies 156 of the first-party server 120 may store an instance of the first-party application 122 and may store the data of the first-party data store 121.

A memory 156 is also capable of storing other instructions and data, including, for example, an operating system, hardware drivers, other software applications, databases, etc. The memory/ies 156 may be coupled to the bus 151 for communication with the processor(s) 154 and the other components of computing system 150.

In some implementations, a memory 156 can include local memory employed during actual execution of the program code, bulk storage, and cache memories that provide temporary storage of at least some program code in order to reduce the number of times code must be retrieved from bulk storage during execution.

Each of the data compliance data store 111, the first-party data store 121, and the third-party data store(s) 134a . . . 134n may be respectively included in their corresponding computing system 150 (e.g., data compliance server 110, first-party server 120, third-party server 131a . . . 131n), or in another computing system and/or storage system distinct from but coupled to or accessible by the computing system 150 via the communication unit 152.

In some implementations, each of the data compliance data store 111, the first-party data store 121, and the third-party data store(s) 134a . . . 134n may be incorporated with the corresponding memory/ies 154 or may be distinct therefrom. In some implementations, each of the data compliance data store 111, the first-party data store 121, and the third-party data store(s) 134a . . . 134n may store data via a database operable on the computing system 150. For example, the database could include a structured query language (SQL) database management system (DBMS), a NoSQL DBMS, and/or any other suitable type of database. In some implementations, the database may store instances (e.g., rows, pairs, sets, etc.) of the data and manipulate, e.g., insert, query, update and/or delete, the instances using programmatic operations.

The input device(s) 158 may include any device for inputting information into the computing system 150. In some implementations, the input device 158 may include one or more peripheral devices. For example, the input device 158 may include a keyboard, a pointing device, microphone, an image/video capture device (e.g., camera), a capacitive layer associated with a touch-screen display, or any other input device.

The output device(s) 160 may include any device capable of outputting information from the computing system 150. The output device(s) 160 may include one or more of a display (e.g., light-emitting diode (LED) display, organic LED display, liquid-crystal display (LCD), projector, electronic glass display, etc.), a printer, a 3D printer, a haptic device, an audio reproduction device, a touch-screen display, etc. In some implementations, an output device 160 may display images and/or data output by the computing system 150 for presentation to a user. The input device(s) 158 and/or the output device(s) 160 can be coupled to the system either directly or through intervening input/output (I/O) controllers. In some implementations, a processor 154 of a computing system 150 may include a graphics adapter for rendering and outputting the images and data for presentation on the output device 160.

The foregoing description, for purpose of explanation, has been described with reference to various implementations and examples. For example, the technology described herein can take the form of a hardware implementation, a software implementation, or implementations containing both hardware and software elements. For instance, the technology may be implemented in resident or distributed executable software, which includes but is not limited to an application, firmware, resident software, microcode, etc. Furthermore, the technology can take the form of a computer program product accessible from a computer-usable or computer-readable medium providing program code for use by or in connection with a computer or any instruction execution system.

The illustrative discussions above are not intended to be exhaustive or to limit the invention to the precise forms disclosed. References in the specification to various “example(s),” “implementation(s),” “embodiment(s),” etc., indicate that the aspects described may include a particular feature, structure, or characteristic, but every embodiment may or may not necessarily include that particular feature, structure, or characteristic. Moreover, such phrases are not necessarily referring to the same features or elements. Further, when a particular feature, structure, or characteristic is described in connection with an embodiment, it is submitted that it is within the knowledge of one skilled in the art to associate or relate any such feature, structure, or characteristic with other embodiments whether or not explicitly described. Additionally, it should be appreciated that items included in a list in the form of “at least one A, B, and C” or “one or more of A, B, and C” or the like can mean (A); (B); (C); (A and B); (A and C); (B and C); or (A, B, and C). Similarly, items listed in the form of “at least one of A, B, or C” or “one or more of A, B, or C” or the like can mean (A); (B); (C); (A and B); (A and C); (B and C); or (A, B, and C).

Also, while various systems, devices, and structures are shown in block diagram form in order to avoid obscuring the description, they may include additional elements or features. Thus, many modifications and variations are possible in view of the above teachings. The various implementations and examples were chosen and described in order to best explain the principles of the invention and its practical applications, to thereby enable others to utilize the innovative technology with various modifications as may be suited to the particular use contemplated.

What is claimed is:

1. A computer-implemented method, comprising:
receiving a data deletion request via a network from a client application, the data deletion request requesting deletion of data about a user;
determining a third-party data processor;
sending a user identification request via the network to the third-party data processor, the user identification request including a unique user identifier for the user and requesting confirmation that the third-party data processor has stored information about the user in a third-party data store;
receiving, via the network, a user identification response confirming that the third-party data processor is storing the information about the user;
responsive to receiving the user identification response, sending, via the network, a third-party data deletion request to the third-party data processor requesting that the third-party data processor delete the information stored about the user in the third-party data store, the third-party data deletion request including the unique user identifier;
receiving, via the network from the third-party data processor, a third-party data deletion response including a transaction identifier for the third-party data deletion request; and
updating, in a data compliance data store, a data deletion record to include the transaction identifier and a timestamp for the third-party data deletion request.

2. The computer-implemented method of claim 1, wherein determining a third-party data processor comprises:
determining profile data of the third-party data processor;
retrieving third-party tracking data associated with the user from a local memory of a computing device of the user;
determining, using the profile data of the third-party data processor, that the third-party tracking data includes a unique user identifier that the third-party data processor uses to uniquely identify the user; and
generating the third-party data deletion request that includes the unique user identifier.

3. The computer-implemented method of claim 2, further comprising:
determining a plurality of third-party data processors associated with a web site loaded in the client application of the user;
providing a user interface for presentation to the user, the user interface including a plurality of user-interactable elements for interacting with the plurality of third-party data processors, respectively; and
receiving an input via an input device of the computing device of the user, the input selecting the third-party data processor via a corresponding user-interactable element from the plurality of user-interactable elements of the user interface.

4. The computer-implemented method of claim 1, further comprising:
for an interval after receipt of the third-party data deletion response, sending, via the network, a periodic status request to the third-party data processor, the periodic status request including the transaction identifier and requesting confirmation that the information stored about the user was successfully deleted from the third-party data store;
receiving, via the network from the third-party data processor, a completion response including the transaction identifier and data verifying that the information stored about the user was deleted from the third-party data store; and
updating, in the data compliance data store, the data deletion record to reflect that the third-party data deletion request was successful and to include a completion timestamp.

5. The computer-implemented method of claim 1, wherein:
the third-party data deletion response confirms that the information stored about the user has been deleted from the third-party data store; and
the computer-implemented method further comprises:
updating the data deletion record to reflect that the third-party data deletion request was successful and to include a completion timestamp;
generating an electronic notification reflecting that the information stored about the user was deleted from the third-party data store; and
sending the electronic notification to an electronic address of the user via the network.

6. The computer-implemented method of claim 1, further comprising:
receiving, via the network from the third-party data processor, a completion response including the transaction identifier and verification data verifying that the information stored about the user was deleted from the third-party data store;
updating, in the data compliance data store, the data deletion record to reflect that the third-party data deletion request was successful and to include a completion timestamp; and
for an interval beginning after receipt of the completion response, sending, via the network, a periodic compliance request to the third-party data processor, the periodic compliance request including the unique user identifier and requesting a subsequent confirmation confirming whether any portion of the information about the user has reappeared in the third-party data store.

7. The computer-implemented method of claim 6, further comprising:
receiving, from the third-party data processor, a compliance response reflecting that at least a portion of the information about the user that reappeared in the third-party data store; and
initiating a subsequent iteration of the computer-implemented method to delete the at least the portion of the information about the user that reappeared in the third-party data store.

8. The computer-implemented method of claim 6, further comprising:
responsive to the interval ending, determining that a compliance criterion is satisfied;
generating an electronic notification reflecting that the information stored about the user successfully was deleted from the third-party data store;
sending the electronic notification to an electronic address of the user via the network; and
purging from the data compliance data store, user-identifying data associated with the data deletion request and the third-party data deletion request.

9. The computer-implemented method of claim 1, wherein:
the data deletion request includes an electronic address of the user; and
the computer-implemented method further comprises:
sending, via the network, a request confirmation notification to the electronic address of the user;
receiving, via the network, a response from the electronic address of the user consenting to the third-party data deletion request; and
updating, the data compliance data store, the data deletion record to reflect the third-party data deletion request has been consented to by the user.

10. The computer-implemented method of claim 1, further comprising:
exposing, via the network, a first application programming interface (API) for receiving data deletion requests from a first-party application, wherein:
the data deletion request is received via the API; and
the user identification request and the third-party deletion requests are sent to the third-party data processor via corresponding APIs exposed by a third-party application of the third-party data processor.

11. A system, comprising:
one or more processors;
one or more memories storing instructions, which when executed by the one or more processors, cause the system to perform operations comprising:
receiving a data deletion request via a network from a client application, the data deletion request requesting deletion of data about a user;
determining a third-party data processor;
sending a user identification request via the network to the third-party data processor, the user identification request including a unique user identifier for the user and requesting confirmation that the third-party data processor has stored information about the user in a third-party data store;
receiving, via the network, a user identification response confirming that the third-party data processor is storing the information about the user;
responsive to receiving the user identification response, sending, via the network, a third-party data deletion request to the third-party data processor requesting that the third-party data processor delete the information stored about the user in the third-party data store, the third-party data deletion request including the unique user identifier;
receiving, via the network from the third-party data processor, a third-party data deletion response including a transaction identifier for the third-party data deletion request; and
updating, in a data compliance data store, a data deletion record to include the transaction identifier and a timestamp for the third-party data deletion request.

12. The system of claim 10, wherein determining a third-party data processor comprises:
determining profile data of the third-party data processor;
retrieving third-party tracking data associated with the user from a local memory of a computing device of the user;
determining, using the profile data of the third-party data processor, that the third-party tracking data includes a unique user identifier that the third-party data processor uses to uniquely identify the user; and
generating the third-party data deletion request that includes the unique user identifier.

13. The system of claim 12, wherein determining a third-party data processor comprises:
determining a plurality of third-party data processors associated with a web site loaded in the client application of the user;
providing a user interface for presentation to the user, the user interface including a plurality of user-interactable elements for interacting with the plurality of third-party data processors, respectively; and
receiving an input via an input device of the computing device of the user, the input selecting the third-party data processor via a corresponding user-interactable element from the plurality of user-interactable elements of the user interface.

14. The system of claim 10, wherein determining a third-party data processor comprises:
for an interval after receipt of the third-party data deletion response, sending, via the network, a periodic status request to the third-party data processor, the periodic status request including the transaction identifier and requesting confirmation that the information stored about the user was successfully deleted from the third-party data store;
receiving, via the network from the third-party data processor, a completion response including the transaction identifier and data verifying that the information stored about the user was deleted from the third-party data store; and
updating, in the data compliance data store, the data deletion record to reflect that the third-party data deletion request was successful and to include a completion timestamp.

15. The system of claim 10, wherein:
the third-party data deletion response confirms that the information stored about the user has been deleted from the third-party data store; and
the operations further comprise:
updating the data deletion record to reflect that the third-party data deletion request was successful and to include a completion timestamp;
generating an electronic notification reflecting that the information stored about the user was deleted from the third-party data store; and
sending the electronic notification to an electronic address of the user via the network.

16. The system of claim 10, wherein the operations further comprise:
receiving, via the network from the third-party data processor, a completion response including the transaction identifier and verification data verifying that the information stored about the user was deleted from the third-party data store;
updating, in the data compliance data store, the data deletion record to reflect that the third-party data deletion request was successful and to include a completion timestamp; and
for an interval beginning after receipt of the completion response, sending, via the network, a periodic compliance request to the third-party data processor, the periodic compliance request including the unique user identifier and requesting a subsequent confirmation confirming whether any portion of the information about the user has reappeared in the third-party data store.

17. The system of claim 15, wherein the operations further comprise:
receiving, from the third-party data processor, a compliance response reflecting that at least a portion of the information about the user that reappeared in the third-party data store; and
initiating a subsequent iteration of at least a portion of the operations to delete the at least the portion of the information about the user that reappeared in the third-party data store.

18. The system of claim 15, wherein the operations further comprise:
responsive to the interval ending, determining that a compliance criterion is satisfied;
generating an electronic notification reflecting that the information stored about the user successfully was deleted from the third-party data store;
sending the electronic notification to an electronic address of the user via the network; and
purging from the data compliance data store, user-identifying data associated with the data deletion request and the third-party data deletion request.

19. The system of claim 10, wherein:
the data deletion request includes an electronic address of the user; and
the operations further comprise:
sending, via the network, a request confirmation notification to the electronic address of the user;
receiving, via the network, a response from the electronic address of the user consenting to the third-party data deletion request; and
updating, the data compliance data store, the data deletion record to reflect the third-party data deletion request has been consented to by the user.

20. A method, comprising:
storing, in a data compliance data store in association with a first-party application, a plurality of third-party application programming interface (API) profiles respectively associated with a plurality of third-party applications;
receiving a data deletion request via a network via the first-party application, the data deletion request requesting deletion of data about a user;
retrieving, from the data compliance data store, the plurality of third-party API profiles associated with the first-party application;
generating, for each third-party application of the plurality of third-party applications, a corresponding a third-party data deletion request based on a corresponding third-party API profile from the plurality of third-party API profiles;
sending, via the network, each third-party data deletion request to the corresponding third-party application via a corresponding API of the third-party application, each third-party data deletion request requesting that the corresponding third-party application delete information stored about the user from a third-party data store of the third-party application;
receiving, via the network, a third-party data deletion response from each third-party application of the plurality of third-party applications, the third-party data deletion response including a corresponding transaction identifier; and
updating, in a data compliance data store, a data deletion record to include the corresponding transaction identifier and a timestamp for each third-party data deletion request.
